(19) United States
(12) Patent Application Publication
(10) Pub. No.: US 2026/0287274 A1
(43) Pub. Date: Sep. 24, 2026

(54) IMPROVEMENTS IN AND RELATING TO NUCLEATION AGENT COMPOSITIONS AND NUCLEATION AGENT PIECES AND METHODS FOR NUCLEATING PHASE CHANGE MATERIALS (PCMs)

(71) Applicant: SUNAMP LIMITED, East Lothian (GB)

(72) Inventors: Gylen ODLING, East Lothian (GB); David OLIVER, East Lothian (GB); Andrew BISSELL, East Lothian (GB)

(21) Appl. No.: 19/475,859

(22) PCT Filed: Apr. 19, 2024
(86) PCT No.: PCT/GB2024/051027

§ 371 Date: Oct. 16, 2025

(30) Foreign Application Priority Data
Apr. 20, 2023 (GB) 2305834.0

(51) Int. Cl. F28D 20/00; C09K 5/06; F28F 21/06

(52) U.S. Cl. CPC F28D 20/0034; C09K 5/063; F28F 21/067; F28D 2020/0047; F28D 2020/0078

(57) ABSTRACT

The present disclosure relates to a nucleation agent piece for a phase change material (PCM), specifically for nucleating a PCM. The present disclosure also relates to a method of preparing the nucleation agent piece, a composition comprising a PCM and the nucleation agent piece, a heat battery device comprising the nucleation agent piece, a method of preparing the heat battery device, and use of the nucleation agent piece in nucleating a PCM.

### FIELD OF THE INVENTION

The present disclosure relates to nucleation agent pieces for a phase change material (PCM), specifically for nucleating a PCM. The present disclosure also relates to a method of preparing the nucleation agent pieces; a composition comprising a PCM and the nucleation agent piece(s); a heat battery device comprising the nucleation agent piece(s), a method of preparing the heat battery device, and use of the nucleation agent piece(s) in nucleating a PCM.

### BACKGROUND OF THE INVENTION

PCMs store and release thermal energy in the latent heat associated with melting and crystallisation, where energy is stored and released as the material transitions across the solid/liquid phase boundary.

Crystallisation in PCMs often does not occur at the thermodynamic melting/freezing temperature, but rather the material will remain as a metastable liquid at temperatures below this point. This is referred to as subcooling or supercooling.

It is typical for PCM compositions to comprise one or more nucleation agent(s) to mitigate or obviate this effect, such that the PCM composition freezes at, or close to, the thermodynamic melting/freezing temperature, or at a more favourable temperature. Nucleation agents may be one or more materials distinct to the main component of the PCM (defined herein as a heterogeneous nucleation agent), or alternatively they may be the same material as the main component of the PCM (i.e. seed crystals).

Typically, nucleation agents are sourced in their microscopic solid form as a loose powder, crystals, granules or flakes and are added to the other PCM components in such a form. They may be added with or without blending into the molten PCM and then settle or collect in a certain locale according to their density relative to the density of the PCM (i.e. may float or sink). This means the location and local loading of the nucleation agent throughout the PCM is not controlled, which affects the performance of the nucleation agent in nucleating the PCM. Moreover, a nucleation agent which is in the form of loose powder may become airborne when used or transported, and therefore is an inhalation risk to workers using said nucleation agent.

Thus, there is a need for a form of nucleating agent which allows the location and local loading of the nucleation agent throughout the PCM to be controlled. It is beneficial to the operation of a PCM composition comprising a nucleation agent to control the location and local loading of the nucleation agent throughout the PCM composition. This allows control of the nucleation and crystallisation regime within the PCM.

Moreover, there is a need for a form of nucleating agent which avoids the inhalation risk associated with powdered (or microscopic) nucleation agents.

The present disclosure addresses the problems mentioned above, as well as the further problems described below.

### SUMMARY OF THE INVENTION

Features of the invention are set forth in the appended claims.

In a first aspect, there is provided a nucleation agent piece for a phase change material (PCM), wherein the nucleation agent piece comprises:
a nucleation agent; and
a hardened resin,
wherein the nucleation agent is dispersed in the hardened resin, and wherein at least a portion of the nucleation agent is present on a surface of the hardened resin.

Herein a “piece” is defined as a quantity of a substance or material forming a single mass or body. The plural. “pieces” is to be understood according (i.e. a plurality of masses or bodies).

In one aspect of the present invention, the nucleation agent pieces of the present invention may take the form of various geometric shapes. In another aspect of the present invention, the nucleation agent piece or pieces comprises a coating which is applied to a surface. Herein a nucleation agent piece may be taken to mean any shape or size of body, including but not limited to a coating layer, droplet, sheet, disc, rod or cylinder. Thus, it is to be understood that the nucleation agent piece(s) may also comprise a composition or device comprising a coating provided on or in a carrier. The carrier may be any surface or may comprise a solid surface for instance, a hardened resin. In the present disclosure, a nucleation agent piece may comprise the nucleation agent powder/granule/flake or other loose form of the nucleation agent dispersed in a solid matrix (i.e. a hardened resin) to provide a macroscopic nucleation agent piece, wherein at least a portion of the nucleation agent is present at the surface of the macroscopic nucleation agent piece. In an alternative embodiment, the nucleation agent piece may comprise a coating of a nucleation agent piece wherein the coating is in contact with a surface and preferably, is connected to that surface. In one embodiment, a coating may be a continuous layer covering a part of whole of a particular surface or formed of discrete portions covering a part of a particular surface. The surface may be, for example, the walls of the container, a heat exchanger surface, pipework, a heat pipe or another similar heat conducting surface. The nucleation agent piece when in the form of a coating is applied as a layer on the surface of surface, wherein the surface is selected according to the predetermined locations in which the nucleation agent piece is best applied in a particular system. Thus by controlling the location of the nucleation agent, therefore the origin of nucleation within a system comprising a PCM is achieved.

Herein, the nucleation agent piece may also be referred to herein as a hardened resin-nucleation agent composite, or a hardened resin-nucleation agent composite piece. The nucleation agent pieces may be described as having form stabilisation, defined as the retention of macroscopic shape without a supporting container.

Herein a “resin” is defined as a polymer precursor which undergoes a reaction to harden to form a hardened resin. This reaction may be the polymerisation of a monomer and/or a cross-linking reaction, which may be driven by addition of a hardener component, which may be water, or exposure to air or light. This reaction may be known as hardening, curing, casting and/or setting. A “hardened resin” is therefore to be understood as the final product of this process, i.e. wherein the liquid resin has undergone a hardening process to produce the solid matrix in which the nucleation agent is dispersed.

Herein “PCM composition” may refer to a composition comprising a PCM and a nucleation agent piece. The term “composition” may be used to refer to the “PCM composition”. The PCM is a latent heat storage material.

The nucleation agent should be in contact or at least in partial contact with the PCM during thermal cycling of e.g. a heat battery device. Therefore, a part or whole of the nucleation agent which forms part of the nucleation agent piece must be located on the surface of the nucleation agent piece, thereby being able to act upon the PCM. Thus, at least a portion of the nucleation agent is present on a surface of the hardened resin.

It is beneficial to the operation of a PCM composition comprising a nucleation agent to control the location and local loading of the nucleation agent throughout the PCM. This allows control of the nucleation and crystallisation regime within the PCM as nucleation and therefore crystal growth will proceed from the vicinity of the nucleation agent. Forming the nucleation agent into a nucleation agent piece allows the location of the nucleation agent to be controlled when placed in a PCM by either forming the nucleation agent piece into a shaped part which may be placed or otherwise located in a certain location, or by forming the nucleation agent piece as a coating which is attached to a selected surface. For instance, the nucleation agent piece can be located on any component of e.g. a heat battery device (pipework, heat conducting apparatus, container wall) in contact with the PCM. This improves the control of the nucleation and crystallization regime within the PCM, relative to e.g. the loose form of the nucleation agent such as a powder.

The nucleation agent piece(s) may be adhered, connected or otherwise bound to any component of e.g. a heat battery device and thereby located within the PCM. The nucleation agent piece may be prepared in such a manner as to use the resinous part of the piece as an adhesive binding the nucleation agent to one or more parts of the heat battery apparatus or other PCM container.

As described herein, loose nucleation agent forms such as powders will tend to concentrate in certain locales according to their density relative to the other PCM components, and therefore crystallisation will proceed from these locales. This may be disadvantageous to the thermal performance of the PCM, or to the stability of the PCM and/or nucleation agent. The present disclosure overcomes this problem by allowing the nucleation agent location to be selected. By way of non-limiting example, the nucleation agent piece may be selectively located by adhering the piece to the PCM container walls, where without forming the nucleation into a piece and adhering it to said walls it would sink to the bottom of the PCM container. By way of further non-limiting example, the nucleation agent piece may be formed in a shape which allows it to be held in a pre-determined location within the PCM container, such as on top of an internal component, or shaped part of the container which acts to support the nucleation agent piece.

It is beneficial to the thermal power and/or temperature output of a PCM for crystallisation and/or nucleation to occur from a plurality of points or areas, such that the thermal output is not limited by the rate of crystal growth, as crystal growth is occurring in many areas simultaneously. In other words, thermal power, to be understood as the release of thermal energy per unit time, correlates with the mass of PCM transitioning to a low temperature phase from a high temperature phase (e.g. to a solid from a liquid). Increasing the number of nucleation points and/or introducing nucleation points which are separated from each other allows greater amounts of material to transition in a given time without the need to wait for a crystal growth front to reach said point(s). With only one or a small number nucleation sites, which may be concentrated in a certain area, nucleation proceeds once the nucleation site(s) are cooled below the phase transition temperature, but the thermal power may be low as the low number of nucleation sites limits the rate that the PCM mass can transition from liquid to solid. This is especially true in the case of PCMs where the rate of crystal growth is slow. It is a benefit of the present disclosure to control the crystal growth regime within the PCM by locating one or more nucleation agent pieces in at least partial or occasional contact with the PCM bulk during thermal cycling. Crystallisation will then proceed from these locales, and control over nucleation and the crystal growth regime within the PCM may be exerted, and the thermal output of the PCM may be improved.

Nucleation agents may also be susceptible to chemical reaction or physical changes such as, but not limited to, phase changes or dehydrations, which may alter their performance. In such situations, it may be beneficial to hinder said changes to retain the activity of the nucleation agent. One or more nucleation agent(s) may be protected from chemical reaction, physical change, or other deactivation process by location of the nucleation agent piece(s) in a region where said deactivation process is ineffective, unlikely or unable to occur to the nucleation agent(s).

Further, it is beneficial to minimise the content of the nucleation agent in a PCM composition to the minimal amount required for reliable nucleation. Increasing the nucleation agent content beyond this minimal amount decreases the energy storage capacity of the PCM composition, while providing no further benefit to the nucleation characteristics of the PCM. Based on the cost of the nucleation agent, which may be higher than that of the PCM components, there may also be a financial motivation to reduce the nucleation agent content of a PCM composition. It is disclosed herein that the nucleation agent pieces may comprise a quantity of the active nucleation agent which is lower than the quantity required for predictable, reliable nucleation should the nucleation agent be used in its loose form (i.e. without being held within a hardened resin).

It is beneficial to the PCM production process to use a nucleation agent which has been made macroscopic in nature by dispersal in a hardened resin, rather than as a loose solid form in terms of safety. As mentioned, nucleation agents are typically powders, which may become airborne when used or transported and therefore are an inhalation risk to workers using said agents. Forming nucleation agent pieces as disclosed in the present disclosure avoids this problem as larger nucleation agent pieces cannot become airborne.

It is also beneficial to deskill and make simple and safe the addition of nucleation agents to the PCM. By removing the need for accurate weighing or metering to be carried out at the same time as the bulk PCM preparation, the process of preparing a PCM composition may be simplified. In the present disclosure, using a nucleation agent which is dispersed in a hardened resin to form a nucleation agent piece does this by exchanging an accurate and slow weighing process with a fast and simple addition of one or more of said nucleation agent pieces into the PCM and/or PCM container/device. The quantity of nucleation agent in the nucleation agent piece is known.

The nucleation agent piece of the present disclosure has a long operating time, allowing tens of thousands of thermal cycles to be carried out without loss of performance. The nucleation agent piece may be prepared where the nucleation agent is retained in the hardened resin on prolonged use of the PCM (i.e. extensive thermal cycling, long periods at high temperatures).

The hardened resin is preferably formed from a resin which is a liquid, in which the nucleation agent may be dispersed before hardening. The resin may also be known as a pre-polymer or monomer or mixture thereof. Dispersal of the nucleation agent within the resin before hardening or before fully hardening the resin allows a part or portion of the nucleation agent to be present at the surface of the nucleation agent piece once hardened. Furthermore provision of a nucleation agent-resin as a liquid allows it to be spread, poured, sprayed or otherwise manipulated before hardening. Such processes may be applied to heat battery components or other surfaces, giving nucleation agent pieces which are adhered, dispersed, layered and/or coated onto said component or surface. Such processes also allow the mixture to be disposed in a mould of a chosen shape before hardening occurs.

It is preferable to use hardened resins which may be formed by the combination of two parts, i.e. the base resin and a hardener, which may be a second monomer, catalyst, initiator or combination thereof, which are mixed together in a specific ratio to cause the hardening of the resin.

In one embodiment, the nucleation agent piece may comprise between about 1 and about 90 wt. % of the nucleation agent, and between about 10 and about 99 wt. % of the hardened resin. In another embodiment, the nucleation agent piece may comprise between about 10 and about 70 wt. % of the nucleation agent, and between about 30 and about 90 wt. % of the hardened resin.

In one embodiment, the hardened resin may be a resin selected from any of the following:
epoxy;
polyester;
polyacrylic;
polyvinylester;
polyurethane;
melamine;
resorcinol-formaldehyde;
urea-formaldehyde;
silicone; and
any combination thereof.

It is a preferred embodiment of the present disclosure to use an epoxy based resin, resulting in a corresponding hardened epoxy resin as the hardened resin in which the nucleation agent is dispersed.

A hardened epoxy resin may be described as the material which results from cross-linking a polyepoxide (polyoxirane) precursor. Crosslinking of epoxy resins may be known as hardening or curing (i.e. it is the process of forming an extensive 3-dimensional network of polymeric chains).

In one embodiment, the nucleation agent comprises a salt, a salt hydrate, an oxide, a carbide, a silicate, or any combination thereof. In another embodiment, the nucleation agent comprises a salt which is recrystallised in a hydrated form. The nucleation agent which is dispersed in the hardened resin constituting the nucleation agent piece may be any selected from the following:
sodium phosphate;
disodium phosphate;
trisodium phosphate;
tetrasodium pyrophosphate;
calcium carbonate;
aluminium oxide;
silicon oxide;
silicon carbide;
silver iodide;
iron oxide;
vermiculite;
titanium dioxide; and
any combination thereof.

The nucleation agent pieces may also comprise water bound to the nucleation agent. The nucleation agent may be in a hydrated crystalline form, such as a di-, tri-, tetra-, penta-, hexa-, or higher hydrated form.

The nucleation agent present in the hardened resin is in its active form, or may become active when in contact with a PCM, which may be water based (i.e. a salt hydrate). The process of activation may be hydration or dehydration. Hydration or dehydration may also be achieved using submersion in water or heating to achieve a specific hydration state.

Waters of crystallisation are herein defined as water molecules that are incorporated into the crystal structure of the material to which they are bound (i.e. the material is a hydrate). The nucleation agent may be a hydrate, or may become a hydrate within the nucleation agent piece and/or in contact with the PCM, where the PCM comprises water.

In one embodiment, the PCM comprises a salt and water, wherein the salt is any selected from the following:
sodium acetate;
sodium formate;
sodium nitrate;
sodium chloride;
sodium sulfate;
calcium nitrate;
calcium chloride;
calcium bromide;
magnesium nitrate;
magnesium sulfate;
magnesium chloride;
magnesium bromide;
strontium bromide;
strontium chloride;
lithium nitrate;
lithium chloride;
lithium bromide; and
any combination thereof.

The PCM may comprise sodium acetate trihydrate, and the nucleation agent may be sodium phosphate, disodium phosphate, trisodium phosphate, tetrasodium pyrophosphate, any hydrates thereof, or any combination thereof.

In another embodiment, the PCM may comprise calcium nitrate tetrahydrate, and the nucleation agent may be magnesium nitrate, strontium nitrate, any hydrates thereof, or any combination thereof.

In another embodiment, the PCM may comprise calcium nitrate tetrahydrate and the nucleation agent may be anhydrous calcium nitrate.

In another embodiment, the PCM may comprise calcium chloride hexahydrate and/or calcium bromide hexahydrate, and the nucleation agent may be strontium chloride, strontium bromide, any hydrates thereof, or any combination thereof.

In another embodiment, the PCM may be a salt-water eutectic selected from any of the following:
Na₂SO₄ (3.5 wt. % in water);
sodium potassium tartrate (5 wt. % in water);
MgSO₄ (19 wt. % in water);
KCl (19.5 wt. % in water);
NH₄Cl (18.6 wt. % in water);
NaOOCH (24.0 wt. % in water);
SrCl₂ (19.5 wt. % in water);
NaNO₃ (35 wt. % in water);
NaOAc (22.7 wt. % in water);
NaOAc (27.0 wt. % in water);
NaCl (22.4 wt. % in water);
LiNO₃ (24.5 wt. % in water);
NaBr (39 wt. % in water);
SrBr₂ (41 wt. % in water); and
Mg(NO₃)₂(29.9 wt. % in water),
and the nucleation agent may be any selected from the following:
calcium carbonate;
aluminium oxide;
silicon oxide;
silicon carbide;
silver iodide;
iron oxide;
vermiculite;
titanium dioxide; and
any combination thereof.

In one embodiment, the nucleation agent piece may be macroscopic. In another embodiment, the nucleation agent piece may have a volume of at least about 0.1 cm³. The size of the nucleation agent pieces are important in controlling their performance.

In another embodiment, the nucleating agent piece may have a surface area of at least about 0.1 cm², or at least 0.5 cm², or at least 1 cm², or at least 5 cm².

In one embodiment, the hardened resin may be a hardened epoxy resin, and the nucleation agent may be sodium phosphate, disodium phosphate, trisodium phosphate, tetrasodium pyrophosphate, any hydrates thereof, or any combination thereof.

The active nucleation agent in its loose form may be blended with one or both of:
a resin liquid
a resin hardener liquid
   which are then mixed in the required ratios and allowed to harden, forming the hardened resin nucleation agent piece.

After mixing but before the material can harden, it may be spread, poured, sprayed or otherwise manipulated, which may take place within or on a heat battery apparatus or any component thereof, or may take place within a mould of a pre-selected shape.

In a second aspect, there is provided a method of preparing a nucleation agent piece, the method comprising:
combining a nucleation agent, a resin, and a resin hardener;
mixing to form a mixture; and
allowing the mixture to harden.

The nucleation agent may be blended into the hardened resin precursors (i.e. the resin and/or the resin hardener) before hardening to give the nucleation agent piece. That is, the nucleation agent may be dispersed, e.g. by mixing, in the resin before hardening. The method therefore may include the step of dispersing the nucleation agent in the resin and/or hardener before hardening the resin.

Dispersal of the nucleation agent aids in ensuring that the nucleation agent is exposed to the PCM, i.e. is at least in part present at the surface of the nucleation agent piece. It is therefore preferable for the resin and/or the hardener to be a liquid in which the nucleation agent may be dispersed. This allows at least a part of the nucleation agent solid(s) to be present at the surface of the nucleation agent piece, and thereby potentially contact the PCM.

The mixing may performed until the resin and hardener are homogeneously mixed, and optionally until the nucleation agent is wetted or substantially wetted.

The nucleation agent piece may be shaped by casting the blended mixture of resin, resin hardener and nucleation agent into a shaped mould. Alternatively, the mixture may be applied to a surface before hardening. Optionally the piece may be cut or shaped once hardened, for example by cutting, drilling, sawing and/or bending.

In one embodiment, the method comprises combining between about 1 and about 90 wt. % of the nucleation agent, between about 5 and about 75 wt. % of the resin, and between about 2 and about 50 wt. % of the resin hardener.

In a third aspect, there is provided a composition comprising a phase change material (PCM) and at least one nucleation agent piece as described herein, wherein the at least one nucleation agent piece is in contact with the PCM.

In one embodiment, the composition may comprise:
between about 98.5 and about 60 wt. % of a sodium acetate trihydrate as the PCM; and
between about 1.5 and about 40 wt. % of at least one nucleation agent piece;
   wherein the hardened resin is a hardened epoxy resin, and the nucleation agent is sodium phosphate, disodium phosphate, trisodium phosphate, tetrasodium pyrophosphate, any hydrates thereof, or any combination thereof, and wherein each nucleation agent piece may have a volume of at least about 0.1 cm³.

The use of nucleation agent pieces during production of PCM composition and/or devices comprising a PCM composition simplifies the production process for operators, and thus aids in scaling up production. In contrast to loose powder nucleation agents, macroscopic nucleation agent pieces may be handled easily with little risk of creating airborne inhalation hazards, and may be metered simply by counting out an appropriate number of pieces. Thus, the process of producing a PCM composition is made quicker, simpler and deskilled.

The present disclosure also discloses the use of control of the location of the nucleation agent pieces to control nucleation and crystallisation growth regimes. It has been found that, in PCM containing devices, control over where the nucleation agent is present in the PCM composition can dramatically affect the system performance.

As mentioned above, a nucleation agent or agents may aggregate, sink, or float in a PCM container, which may be disadvantageous for the thermal output of the system and may cause unwanted chemical reaction or physical change to the nucleation agent or PCM. For example, if a nucleation agent sinks in the bulk PCM then it will collect at the bottom of the PCM container, and hence when the PCM is cooled, nucleation will commence at the bottom of the container and the crystal growth front will trend upwards. This is disadvantageous if it is preferred that nucleation occurs at the top of the PCM container, due to, for example, a cooling regime which acts from the top of the PCM container downward. In this scenario, the PCM located at the top of the container will subcool extensively until the bottom of the PCM container is cooled sufficiently to nucleate and the crystallisation front which begins at the bottom has time to travel to the top. This effect may be particularly significant and detrimental to the performance of a PCM containing device if the PCM exhibits a slow rate of crystal growth (i.e. the crystals, once nucleated, grow slowly and therefore the crystallisation front travels slowly through the PCM as it freezes).

The present disclosure discloses various methods by which the spatial distribution or concentration of one or more nucleation agent(s) in a PCM may be controlled by using nucleation agent pieces.

Nucleation agents may be immobilised within the PCM container when formed into a piece by blending with a resin and hardening either in place (i.e. hardening on a pre-determined surface) or being shaped such that the piece remains in a location chosen by the manufacturer.

Nucleation agent pieces may be formed of a resin within which a nucleation agent is dispersed, applied to a pre-determined surface and then hardened, thereby adhering the nucleation agent piece to the pre-determined surface.

Herein immobilisation is defined as remaining in place, in contrast to being free to move (i.e. as if it were a loose powder or small particles). Nucleation agent pieces may be immobilised by adhering the piece to a surface, or by shaping the piece such that it is unable to significantly move within the PCM container.

In a fourth aspect, there is provided a heat battery device comprising:
a container;
a phase change material (PCM) located in the container;
one or a plurality of nucleation agent piece(s) as defined herein located in the container; and
one or more heat exchanger(s) located in the container, wherein said heat
exchanger(s) comprise one or more means for the addition and removal of heat from the heat battery device.

A heat battery or heat battery device may be referred to as a thermal energy storage device, thermal store, thermal bank or thermal buffer.

It is beneficial to the operation of a heat battery device comprising a PCM and a nucleation agent to control the location and local loading of the nucleation agent throughout the PCM within the heat battery device. Forming the nucleation agent into a nucleation agent piece (or coating) allows the location of the nucleation agent on any component (i.e. pipework, heat conducting apparatus, container wall) in contact with the PCM.

The heat battery device of the present disclosure has improved performance, cycle stability and/or reliability due to the location of the nucleation agent, which may be controlled due to its inclusion in a hardened resin.

The heat battery disclosed as part of the present disclosure may optionally comprise one or more electric heating elements.

A further disclosure is the use of nucleation agent pieces to increase the thermal power output of the PCM system.

The distribution of said nucleation agent pieces may be designed such that areas of particularly high heat removal from the system such as, for example, an internal heat exchanger or the container walls have a permanently high nucleation agent content.

Furthermore, immobilising and controlling the distance between nucleation centres is disclosed as an important method to improve thermal power output of PCM systems, particularly where the growth of the crystals of the PCM is slow.

A further disclosure is the location of nucleation agent pieces within the PCM container to mitigate various performance reducing deactivation processes of the PCM, nucleation agents or both.

A plurality of nucleation agent pieces may be used in the present disclosure.

Within a single nucleation agent piece, one or a plurality of nucleation agents may be present.

The nucleation agent pieces may be located on, around, or substantially in contact with one or more surfaces of a heat exchanger of the heat battery device.

The nucleation agent pieces may take the form of a coating or layer which is located on one or more surface of the heat battery. The nucleation agent layer is in contact or partial or temporary contact with the PCM during the operation of the heat battery.

The nucleation agent piece may be located on one or more heat conductive surface(s) in the container. A heat conductive surface may be a metallic, plastic, glass, graphitic or other planar material and/or ceramic surface which allows the efficient transfer of heat. Preferably the nucleation agent piece is located on a metallic surface, more preferably, on a metallic surface which forms part of a heat exchanger apparatus, wherein the heat exchanger apparatus is preferably a heat exchanger apparatus which supplies cooling to the PCM.

The nucleation agent piece may be located on a heat exchanger surface which is also in contact with the PCM. Preferentially, the nucleation agent piece, which may be in the form of a coating or layer, may be located on a heat exchanger surface which is used to introduce cooling into the heat battery. The surface which is used to introduce cooling into the heat battery may be the external surface of a pipe, or heat spreading surface such as a fin extending from such.

The nucleation agent pieces may be located in contact with the PCM and a heat exchanger inlet supplying cooling.

In one embodiment, the nucleation agent piece(s) may be in direct contact with both the PCM and one or more heat exchangers. In one embodiment, the nucleation agent piece(s) may be in direct contact with both the PCM and one or more means for the removal of heat from the heat battery device.

In one embodiment, one or more heat exchanger(s) may be fin-tube heat exchangers with at least one inlet for a heat transfer fluid; and the nucleation agent piece(s) may be located in one or more of the locations selected from the following:
on the surface of one or more heat spreading fins of the fin-tube heat exchanger;
on the surface of one or more manifolds of the fin-tube heat exchanger; and on the surface of one or more heat exchanger cooling inlet pipes of the fin-tube heat exchanger.

In one embodiment, each nucleating agent piece may be less than 50 cm, less than 20 cm, less than 10 cm, less than 5 cm or less than 2 cm apart from another nucleating agent piece in the heat battery device.

In one embodiment, in addition to the nucleation agent piece(s), the heat battery device may further comprise a loose form of the nucleation agent (e.g. a powdered, granule, flake or other solid form of the nucleation agent).

In a fifth aspect, there is provided a method of preparing a heat battery device, comprising adhering the nucleation agent piece(s) to the one or more heat exchanger(s) by applying a mixture to one or more of the surfaces of the one or more heat exchanger(s), wherein the mixture comprises a nucleation agent, a resin and a resin hardener; and allowing the mixture to harden.

Herein allowing the resin to harden may be taken to mean allowing the mixture of resin, hardener and nucleation agent to stand for a period of time sufficient to produce the nucleation agent piece. During this time, the resin/hardener/nucleation agent mixture turns from a suspension or dispersion of solids in a liquid to a solid piece comprising the hardened resin comprising the nucleation agent. Depending on the amount of hardener and the conditions (i.e. temperature, pressure, application of light and/or moisture) the hardening process may take longer or shorter time periods. Ideally the hardening process takes place in a timescale which allows the nucleation agent to be dispersed within the resin and/or hardener and mixing of all components. Additional time may be required to transfer the resin/hardener/nucleation agent mixture into a mould, or spread, pour, spray or otherwise apply the mixture to a surface, which may be a surface within a heat battery. Thus, it may be preferable to select a resin and hardener combination which provides a fully hardened piece in more than 1 minute, more than 5 minutes, more than 20 minutes, more than 1 hour, more than 3 hours or more than 6 hours.

In one embodiment, one or more heat exchanger(s) may be fin-tube heat exchangers, and the method may comprise applying the nucleation agent mixture before hardening occurs to one or more of the locations selected from:
on the surface of one or more heat spreading fins of the fin-tube heat exchanger;
on the surface of one or more manifolds of the fin-tube heat exchanger; and on the surface of one or more heat exchanger cooling inlet pipes of the fin-tube heat exchanger.

In another embodiment, the resin may be an epoxy resin and the resin hardener may be an epoxy resin hardener.

The method of application may comprise mixing one or more nucleation agent(s) with one or both of a liquid phase resin and/or a liquid phase resin hardener and blending before applying to the one or more heat exchanger surfaces and allowing the mixture to harden.

The nucleation agent may be blended with the resin and/or hardener and stored before being combined with the other component (i.e. the resin or hardener) and applied to the one or more heat exchanger surface(s).

The application of the nucleation agent piece to the heat exchanger may preferentially take place before the introduction of the PCM into the heat battery device.

The nucleation agent piece may be applied to the heat exchanger in regions where cooling is introduced into the heat battery device. Preferably the nucleation agent piece is applied to a heat exchanger surface where cooling in inlet into the heat exchanger (i.e. the external surface of a pipe supplying cooling, or heat spreader adjacent to such).

In a sixth aspect, there is provided a use of the nucleation agent piece in nucleating a PCM. The foregoing aspects and embodiments should not be read to limit or otherwise narrow the scope of any of the inventive concepts otherwise provided by the present disclosure. While multiple embodiments are disclosed, other embodiments will become apparent to those skilled in the art from the following description and drawings. Accordingly, the description and drawings are to be regarded as illustrative rather than restrictive.

### DESCRIPTION OF THE FIGURES

It should be noted that the accompanying figures referred to herein are not necessarily drawn to scale but may be exaggerated to illustrate various aspects of the present disclosure, and in that regard, the figures should not be construed as limiting.

FIG. 1 shows a schematic representation of a hardened resin-nucleation agent composite piece (1) in contact with a PCM (3) in a PCM container (4), wherein the nucleation agent itself (2) is bound to the hardened resin while also being in contact with the PCM.

FIG. 2 shows a schematic representation of one method by which a hardened resin-nucleation agent composite may be produced;

FIG. 3 shows crystallisation of a PCM proceeding from a hardened resin-nucleation agent piece located at the bottom of the PCM container;

FIG. 4 shows crystallisation of a PCM proceeding from a hardened resin-nucleation agent piece located at the top of the PCM container;

FIG. 5 shows the process of coating a surface with a hardened resin-nucleation agent piece, using a pipe as an example surface;

FIG. 6 shows an embodiment of the present disclosure, wherein the hardened resin-nucleation agent pieces are situated at the top of a PCM container when used in combination with an electrical heating element and the charging and discharging energy is optimised in opposite directions;

FIG. 7 shows inlet and outlet temperatures of a heat battery device on discharge where the PCM subcools due to degradation of the nucleation agent which is located near an immersed heating element used to charge the PCM;

FIG. 8 shows subcooling of a PCM which does not comprise a hardened-resin nucleation agent composite measured using temperature sensors distributed vertically throughout the PCM sample;

FIG. 9 shows nucleation of a PCM from the top using temperature sensors distributed vertically throughout the PCM sample, wherein the PCM does comprise a hardened resin-nucleation agent composite located at the top of the heat battery device;

FIG. 10 shows outlet temperature profiles during discharge of a heat battery device comprising hardened resin-nucleation agent pieces located on the uppermost surfaces of a heat exchanger device submerged within a PCM within the heat battery device;

FIG. 11 shows outlet temperature profiles and internal temperature profiles from within the PCM during discharge of a heat battery comprising hardened resin-nucleation agent pieces located on the uppermost surfaces of a heat exchanger device submerged within a PCM within the heat battery device after a 24 hour hot soak applied via the heat exchanger;

FIG. 12 shows outlet temperature profiles and internal temperature profiles from within the PCM during discharge of a heat battery comprising hardened resin-nucleation agent pieces located on the uppermost surfaces of a heat exchanger device submerged within a PCM within the heat battery device after a 24+ hour hot soak applied using an electric element submerged in the PCM and located at the bottom of the heat battery device;

FIG. 13 shows outlet temperature profiles and internal temperature profiles from within the PCM during discharge of a heat battery comprising hardened resin-nucleation agent pieces located on the uppermost surfaces of a heat exchanger device submerged within a PCM within the heat battery device, where the discharge flow is either top-down or bottom-up through the heat exchanger;

FIG. 14 shows an example fin-tube heat exchanger apparatus to which a hardened resin-nucleation agent composite may be applied, comprising inlet/outlet pipes (5,9) connected to a fin-tube section (7) via an upper (6) and lower (8) manifold section.

FIG. 15 shows an example of a section of a fin-tube heat exchanger apparatus and locations upon which a hardened resin-nucleation agent composite may be applied. The heat exchanger comprises an inlet pipe supplying cooling (10) connected to manifold pipe (11) which splits the coolant flow into smaller pipes (12) which form the tubes of a fin-tube heat exchanger core (13) by their intersection with a plurality of fins. Points (14) indicate examples of locations that could be used for hardened resin-nucleation agent composite pieces.

FIG. 16 shows a PCM exhibiting an inhomogeneous temperature distribution. Zones of PCM with a temperature below that of the melting transition of the PCM (15 & 19), are separated by a zone of PCM with a temperature higher than that of the melting transition of the PCM (16). Nucleation from a nucleation agent located at the bottom of the PCM volume (17) is shown to cause crystal growth upward according to arrow 18 until it reaches the PCM zone with a temperature greater than the melting transition temperature of the PCM (16). No crystal growth in the PCM zone 15 is achieved.

FIG. 17 shows a PCM exhibiting an inhomogeneous temperature distribution. Zones of PCM with a temperature below that of the melting transition of the PCM (20 & 24), are separated by a zone of PCM with a temperature higher than that of the melting transition of the PCM (21). Nucleation from a nucleation agent located at the bottom of the PCM volume (22) is shown to cause crystal growth upward according to arrow 23 until it reaches the PCM zone with a temperature greater than the melting transition temperature of the PCM (21). Nucleation from the nucleation agent located at the top of the PCM volume (25) is shown to cause crystal growth according to arrow 26 until it reaches the PCM zone with a temperature greater than the melting transition temperature of the PCM (21). Crystal growth in both PCM zones 20 and 24 is achieved.

### DETAILED DESCRIPTION

The present disclosure relates to a nucleation agent piece for a phase change material (PCM), specifically for nucleating a PCM. The present disclosure also relates to a method of preparing the nucleation agent piece, a composition comprising a PCM and the nucleation agent piece, a heat battery device comprising the nucleation agent piece, a method of preparing the heat battery device, and use of the nucleation agent piece in nucleating a PCM.

When a PCM is molten at elevated temperature and then cooled below its thermodynamic melting point, crystallisation is thermodynamically allowed. However, many PCMs remain liquid below this temperature, trapped in a metastable state. This process is known as subcooling or supercooling. In such cases it is typical to employ one or more nucleation agent(s) to ensure that crystallisation proceeds. Such nucleation agents may be homogeneous (i.e. of the same chemical identity as the PCM, i.e. seed crystals) or heterogeneous (i.e. a different material which initiates crystallisation in the PCM). It is typical for nucleation agents to take the form of loose powders, flakes or granules, and for the materials to therefore settle in a particular area of the PCM according to their density relative to the density of the bulk PCM, and therefore for the manufacturer and user(s) to have no input over their location or dispersal. In this situation, nucleation will initiate from the location of the loose powder, flakes or granules of nucleation agent, which may not be advantageous to the operation of the PCM. For example, the area in which the loose nucleation agent has gathered may experience low thermal flux when the system is cooled, and therefore it will cool at a lower rate than other regions of the PCM. This means crystallisation will be delayed and areas of the PCM where the nucleation agent has not settled will still subcool. For further example, the loose form of the nucleation agent will tend to collect in certain areas of the PCM (e.g. they may sink), and thus crystallisation may proceed from this area only. However, to maximise the thermal power of the system, nucleation from a plurality of locations is preferable, especially in cases where the crystal growth rate is low.

Thus, as explained above, there are benefits in controlling the location of nucleation agents within a PCM composition or PCM composition containing device, as the nucleation and crystallisation regime may also be controlled thereby. The present disclosure allows for the location of the nucleation agent to be controllable, selectable and more precise by using a nucleation agent piece, which is a nucleation agent dispersed in a hardened resin, which may be located within a PCM container in a beneficial location, including in contact with one or more surface(s).

Nucleation agents may be modified by the methods described herein into pieces, which may take a variety of shapes and form factors, including coatings and/or layers which are attached to various surfaces within the PCM and/or device comprising a PCM.

The present disclosure provides a nucleation agent piece for a phase change material (PCM), wherein the nucleation agent piece comprises:
a nucleation agent; and
a hardened resin,
wherein the nucleation agent is dispersed in the hardened resin, and wherein at least a portion of the nucleation agent is present on a surface of the hardened resin.

A resin is described herein as a pre-polymer, monomer, polymer, or mixture of such, preferably in the liquid phase under standard temperature and pressure which may undergo a hardening process to form the final hardened resin. This reaction may be the polymerisation of a monomer and/or a cross-linking reaction, which may be driven by addition of a hardener component, which may be water, or exposure to air or light. This reaction may be known as hardening, curing, casting and/or setting. A hardened resin is therefore to be understood as the final product of this process, i.e. wherein the liquid resin has undergone a hardening process to produce the solid matrix in which the nucleation agent is dispersed, including a part of the nucleation agent which is present at the surface of the solid matrix. Hardened resins may also be described as adhesives and may have a secondary function as an adhesive.

The nucleation agent piece may be described as being form stabilised, or having form stability, defined as having the retention of macroscopic shape without a supporting container. This is in contrast to powders, granules or flakes, which would form a pile with a characteristic angle of repose when their supporting container is removed.

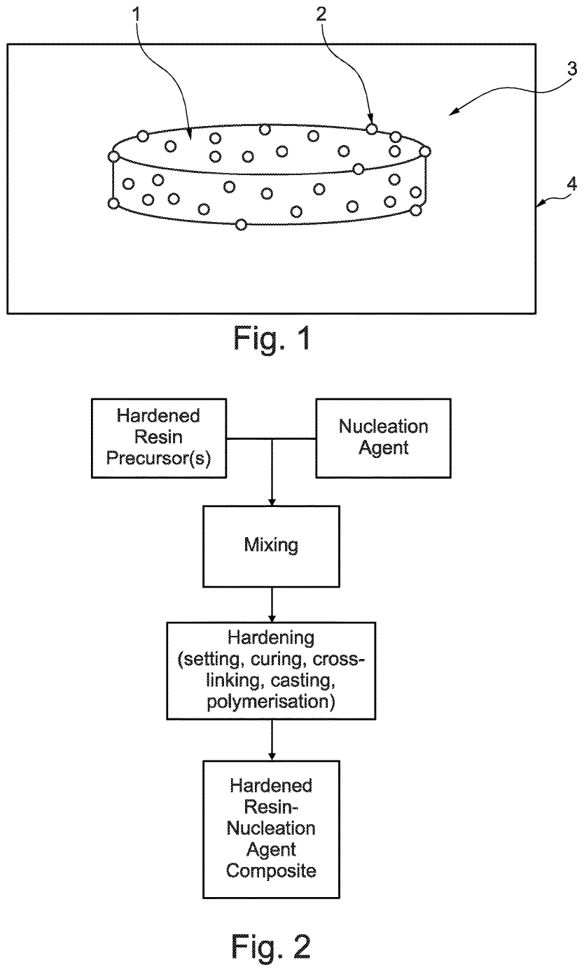

The nucleation agent piece needs to be in contact with the PCM of a device in which it is used, at least intermittently during thermal cycling of the PCM. Furthermore, the nucleation agent that is dispersed in the hardened resin should be in contact with the PCM during thermal cycling. Therefore, a part or whole of the nucleation agent which forms part of the nucleation agent piece must be located on the surface of the piece, thereby being able to act upon the PCM. This is shown schematically in FIG. 1. It is unlikely that any nucleation agent which is fully encapsulated by the hardened resin, and therefore not in contact with the PCM at all, would have any effect on the nucleation of the PCM. Maximising the nucleation agent at the surface of the nucleation agent piece is beneficial to its performance. Therefore, forming the nucleation agent piece in such a way in which the surface is maximised (e.g. small piece sizes, droplets, thin layers, coatings, and porous versions thereof), is beneficial.

The surface area of the nucleation agent piece may be at least about 0.1 cm², or at least about 0.5 cm², or at least about 1 cm², or at least about 5 cm². A larger surface area may mean more nucleating agent is present on the surface of the nucleation agent piece. The nucleation agent piece may have a volume of at least about 0.1 cm³.

The hardened resin may be any polymer or hardened resin selected from any of the following:
epoxy;
polyester;
polyacrylic;
polyvinylester;
polyurethane;
melamine;
resorcinol-formaldehyde;
urea-formaldehyde;
silicone; and
and combination thereof.

It has been found by the inventors that other strategies for producing form stabilised nucleation agent pieces have reduced effectiveness compared to the combination of the nucleation agent with a hardened resin as disclosed herein. Methods of form stabilisation typical in the prior art, such as thickening or compression, fail to produce form stabilised pieces with good activity and longevity. For example, thickened mixtures of nucleation agents tend to have poor nucleation activity, which is thought by the inventors to be due to the high viscosity of the composite and the propensity for the thickening agent to leech into the PCM. For further example, it has been found by the inventors that compressed nucleation agents may provide form stabilisation and nucleating activity, however after prolonged thermal cycling (i.e. melt-freeze cycles) the form stabilisation is lost as the piece cracks, crumbles or is otherwise abraded by the repeated cycling. This results in the loss of nucleation agent from the area of the PCM container which was selected for optimal nucleation performance, and may cause all of the nucleation agent to be lost from this area.

It has been found by the inventors that nucleation agent pieces comprising a hardened resin and nucleation agent have improved longevity without losing nucleation agent performance. While only the external surfaces of such a nucleation agent piece are active, as only that material which is in contact with the PCM can initiate crystallisation, it has been found that reliable crystallisation can be achieved and that this performance can be demonstrated for extended periods of time and repeated melt-freeze cycles. Further, due to the mechanical strength of hardened resins, the pieces produced as disclosed herein have a long lifetime, do not deform, deactivate, lose their form, leach nucleation agent and/or undergo mechanical failure in the PCM, despite prolonged thermal cycling. It is disclosed herein that, despite some nucleation agents being slightly soluble in PCMs, that when bound in a hardened resin they unexpectedly do not leech from the composite agent piece/coating.

Nucleation agent pieces as claimed herein have been found to allow reliable, predictable and effective nucleation activity after more than 500 thermal cycles, more than 1000 thermal cycles, more than 2500 thermal cycles, more than 5000 thermal cycles or more than 10,000 thermal cycles.

For the longevity of the performance of a nucleation agent piece, it is preferred to fully harden the resin, and as such resins which allow a high loading of nucleation agent, which may be salts, salt hydrates, metal oxides, metal carbides, metal silicates or other nucleation agent materials, are preferred.

Polyurethane resins are disclosed herein as hardened resins in which the one or more salt and/or salt hydrate nucleation agents may be dispersed at high loadings with full hardening. Using a polyurethane as the hardened resin, up to about 90 wt. % of a salt and/or salt hydrate nucleation agent may be dispersed in the nucleation agent piece without hardening issues.

Epoxy resins are disclosed herein as hardened resins in which the one or more nucleation agents are dispersed. As epoxies have a widest compatibility with salt and/or salt hydrate nucleation agents, and have the simplest practical considerations during curing, they are well suited to application in this manner. Up to about 90 wt. % of a nucleation agent, which may be a salt and/or salt hydrate, or a metal oxide, carbide or silicate, can be reliably included in the epoxy precursors without compatibility issues and give a hardened final composite product.

A further technical benefit of epoxy resins disclosed herein is the ease of handling and lack of hazardous materials included in epoxy formulations. Resinous precursors may include organic solvents, stabilisers, clarification or other modifying agents which may off-gas during the hardening process. These are typically toxic and require careful controls to be in place to avoid risk to users. Of particular concern is the release of styrene gas, which must be protected against when many resins are used. In contrast, epoxies are largely non-hazardous, and may be handled with relative ease.

The hardened resin is preferably a hardened epoxy resin or a hardened polyurethane, more preferably a hardened epoxy resin.

Hardened resins may be selected according to their stability in the PCM, compatibility with other components present in the system which comprises the PCM, resistance to degradation, particularly under elevated temperatures and in contact with the PCM, which may exhibit extremes of pH. More particularly the hardened resin is selected for stability under thermal cycling (i.e. should be hard wearing under repeated melt-freeze cycles).

It has been found by the inventors that the dispersion of the nucleation agent within the hardened resin is an important parameter. For successful nucleation of the PCM, it is proposed by the inventors that the nucleation agent is accessible to the PCM, and thus is present at least in part at the surface of the hardened resin. In other words, the surface of the nucleation agent piece comprises at least a part of the nucleation agent. This surface is then in contact with the PCM. At least a portion of the nucleation agent is on a surface of the hardened resin. The surface of the hardened resin may be substantially covered in nucleation agent.

The nucleation agent content of the nucleation agent piece is therefore an important parameter. There should be sufficient nucleation agent loading to ensure that a portion of the nucleation agent is present at the surface of the nucleation agent piece, and as such may be in contact with the PCM during use, however this also depends on the size and form factor of the nucleation agent piece.

The nucleation agent piece must comprise a minimum amount of nucleation agent, to ensure that nucleation proceeds. However, increasing the loading of nucleation agent beyond this minimum may be beneficial in terms of the applicability of the mixture, with such factors as the mixtures rheology before hardening, its density, and the gelation time being affected by the mass loading of the nucleation agent.

The loading of nucleation agent may be as little as 1 wt. % in the nucleation agent piece, with the remaining mass being comprised of hardened resin. Using such a loading may be preferable where the nucleation agent piece is in a thin layer or other form factor which exhibits high surface area. The loading of the nucleation agent may preferably be between about 25 wt. % and 50 wt. % of the piece, or more preferably still around 50 wt. % of the piece, with the remaining mass being comprised of hardened resin. The loading of the nucleation agent may be up to about 90 wt. % of the nucleation agent piece, with the remaining mass being comprised of the hardened resin. Increasing the loading of nucleation agent in the nucleation agent pieces above about 50 wt. %, up to about 90 wt. %, has been found by the inventors to result in a mixture which has an increasingly high viscosity and paste-like consistency. Increasing the mass loading of the nucleation agent beyond about 90 wt. % has been found by the inventors to result in a mixture where a portion of the nucleation agent cannot be wetted by the resin components, and as such does not result in a single macroscopic piece on hardening. Such high loadings have been found to produce nucleation agent pieces which are flaky, dusty or delicate in nature, and cannot be easily applied to a surface due to the lack of nucleation agent particle wetting by the resin components.

Therefore, the nucleation agent piece may comprise between about 1 to about 90 wt. % of a nucleation agent and between about 10 and about 99 wt. % of a hardened resin. The nucleation agent piece may comprise between about 5 to about 85 wt. % of a nucleation agent, or between about 10 to about 80 wt. % of a nucleation agent, or between about 10 to about 75 wt. % of a nucleation agent, or between about 10 to about 70 wt. % of a nucleation agent, or between about 10 to about 60 wt. % of a nucleation agent, or between about 20 to about 60 wt. % of a nucleation agent, or between about 30 to about 50 wt. % of a nucleation agent, or between about 30 to about 55 wt. % of a nucleation agent, or between about 35 to about 50 wt. % of a nucleation agent, or about 50 wt. % of a nucleation agent, with the remaining mass of the nucleation agent piece being comprised of the hardened resin. That is, the nucleation agent piece may comprise between about 15 to about 95 wt. % of a hardened resin, or between about 20 to about 90 wt. % of a hardened resin, or between about 25 to about 90 wt. % of a hardened resin, or between about 30 to about 90 wt. % of a hardened resin, or between about 40 to about 90 wt. % of a hardened resin, or between about 40 to about 80 wt. % of a hardened resin, or between about 50 to about 70 wt. % of a hardened resin, or between about 45 to about 70 wt. % of a hardened resin, or between about 50 to about 65 wt. % of a hardened resin, or about 50 wt. % of a hardened resin, with the remaining mass of the nucleation agent piece being comprised of the nucleation agent.

The nucleation agent piece comprises a sufficient amount of nucleation agent, and particularly a sufficient amount of nucleation agent at the surface of the hardened resin, to ensure the required PCM is nucleated as desired.

The PCM may be selected salts and/or salt hydrates comprising one or more salts from:
sodium acetate,
sodium formate,
sodium nitrate,
sodium chloride,
sodium sulfate,
calcium nitrate,
calcium chloride,
calcium bromide,
magnesium nitrate,
magnesium sulfate,
magnesium chloride,
magnesium bromide,
strontium bromide,
strontium chloride,
lithium nitrate,
lithium chloride,
lithium bromide.

The nucleation agent may comprise a salt, a salt hydrate, an oxide, a carbide, a silicate, or any combination thereof. The nucleation agent may comprise a salt which is recrystallised in a hydrated form. Said recrystallisation may occur when the nucleation agent piece is applied to the PCM, i.e. water may be absorbed into the nucleation agent while it is in contact with the PCM.

In an embodiment of the present disclosure, the PCM is a salt hydrate comprising sodium acetate and water, or preferably sodium acetate trihydrate, and the nucleation agent comprises sodium phosphate, disodium phosphate, trisodium phosphate, tetrasodium pyrophosphate, any hydrates thereof, or any combination thereof, preferably disodium phosphate and any hydrates thereof.

In an embodiment of the present disclosure, the PCM is a salt hydrate comprising calcium nitrate and water, or preferably calcium nitrate tetrahydrate, and the nucleation agent comprises magnesium nitrate, strontium nitrate, any hydrates thereof, or any combination thereof.

In an embodiment of the present disclosure, the PCM is a salt hydrate comprising calcium nitrate and water, or preferably calcium nitrate tetrahydrate, and the nucleation agent comprises anhydrous calcium nitrate.

In an embodiment of the present disclosure, there is provided a nucleation agent for calcium nitrate tetrahydrate, comprising:
between about 1 and 90 wt. % of magnesium nitrate, strontium nitrate, any hydrates thereof, or any combination thereof; and between about 10 and 99 wt. % of an epoxy;
wherein preferably strontium nitrate and/or any hydrate form thereof is used.

In an embodiment of the present disclosure, the PCM is a salt hydrate comprising calcium chloride hexahydrate and/or calcium bromide hexahydrate, and the nucleation agent comprises strontium chloride, strontium bromide, any hydrates thereof, or any combination thereof. Preferably strontium chloride is used when the PCM is calcium chloride hexahydrate or substantially comprises calcium chloride hexahydrate, and preferably strontium bromide is used when the PCM is calcium bromide hexahydrate or substantially comprises calcium bromide hexahydrate. The hardened resin is preferably a hardened epoxy resin in this embodiment.

The PCM may be a salt-water eutectic, defined as a material comprising a salt and water, where the composition has a melting point below 0° C.

The PCM may be a salt-water eutectic, and the nucleation agent may be one or more of:
calcium carbonate,
aluminium oxide,
silicon oxide,
silicon carbide,
silver iodide,
iron oxide,
vermiculite, and
titanium dioxide.

In an embodiment of the present disclosure, the PCM is a salt water eutectic comprising a salt in water selected from any of the following:
Na₂SO₄ (3.5 wt. % in water),
Sodium potassium tartrate (5 wt. % in water),
MgSO₄ (19 wt. % in water),
KCl (19.5 wt. % in water),
NH₄Cl (18.6 wt. % in water),
NaOOCH (24.0 wt. % in water),
SrCl₂ (19.5 wt. % in water),
NaNO₃ (35 wt. % in water),
NaOAc (22.7 wt. % in water),
NaOAc (27.0 wt. % in water),
NaCl (22.4 wt. % in water),
LiNO₃ (24.5 wt. % in water),
NaBr (39 wt. % in water),
SrBr₂ (41 wt. % in water), and
Mg(NO₃)₂(29.9 wt. % in water)
and the nucleation agent is selected from any of the following:
calcium carbonate,
aluminium oxide,
silicon oxide,
silicon carbide,
silver iodide,
iron oxide,
vermiculite,
titanium dioxide,
and any combination thereof.

Nucleation agent pieces may be described as form stable, which is defined herein as having the property of the retention of macroscopic shape without a supporting container. For example, a small cubic piece would remain cubic when removed from a cubic mould. This is a property imparted by the hardened resin matrix, without which the nucleation agent would be a loose powder, flake or granules which would not hold the shape of the container when the container is removed. The nucleation agent pieces may therefore be shaped into a variety of different shapes according to the volume available and location desired within the PCM.

The nucleation agent pieces may have a volume of: greater than about 0.01 cm³; greater than about 1 cm³; greater than about 5 cm³; greater than about 10 cm³; greater than about 25 cm³; greater than about 50 cm³; greater than about 75 cm³; greater than about 100 cm³; greater than about 500 cm³; greater than about 1,000 cm³; greater than about 5,000 cm³; or greater than about 10,000 cm³.

The nucleation agent pieces may have a volume of: about 0.1 cm³ to 10 cm³; about 0.1 cm³ to 100 cm³; about 0.1 cm³ to 5,000 cm³; or about 0.1 cm³ to 10,000 cm³; or about 0.1 cm³ to 100,000 cm³; or about 0.1 cm³ to 1,000,000 cm³.

Nucleation agent pieces of such sizes both behave and may be handled as individual self-supporting macroscopic pieces. In contrast, powders or granules, which can be considered to be form stabilised on a much smaller scale, behave closer to a liquid (i.e. they are not macroscopically self-supporting, do not behave as a single item, are capable of flowing).

Thus, a loose powder must be handled with this in mind, complicating their use. For example, loose powders require a container for use and metering, are capable of forming potentially hazardous airborne suspensions, and require equipment to transfer from one place to another, or to accurately introduce into the PCM. Furthermore, once introduced into the PCM, a loose powder will move freely according to its density with respect to the density of the other PCM components, typically collecting in certain locales within the PCM, giving the manufacturer or user no control over where it is finally situated.

To avoid these problems, forming of nucleation agents into larger pieces is preferable. To access the benefits of using a macroscopic form stable nucleation agent, it is therefore necessary to blend the material with hardened resin precursors (i.e. a resin and a means of hardening, which may be a hardener material, heat, light, or moisture) in pieces which are macroscopic in nature (i.e. larger in size than a loose powder). The inventors have found that form stabilisation of nucleation agents as described herein may be at least about 0.1 cm³ in size, and thereby act as individual macroscopic components rather than one or a collection of loose particles.

Nucleation agent pieces may also comprise one or more density modification agents (i.e. a material with a density differing from that of the PCM), and as such give a nucleation agent piece which may float in the PCM. The density modification agent may comprise more than about 1, 3, 5, or 10 wt. % of the pieces. The density modification agent may also be the inclusion of voids into the pieces. Inclusion of up to about 50 vol %, or up to about 40 vol %, or up to about 30 vol %, or up to about 20 vol %, air bubbles into the nucleation agent pieces may be used to cause the piece to float.

The present disclosure provides a method of preparing the nucleation agent piece described herein, the method comprising:
combining a nucleation agent, a resin, and a resin hardener;
mixing to form a mixture; and
allowing the mixture to harden.

Herein allowing the resin to harden may be taken to mean allowing the mixture of resin, hardener and nucleation agent to stand for a period of time sufficient to produce the nucleation agent piece. Depending on the amount of hardener and the conditions (i.e. temperature, pressure, application of light and/or moisture) the hardening process may take longer or shorter time periods. Ideally the hardening process takes place in a timescale which allows the nucleation agent to be dispersed within the resin and/or hardener and mixing of all components. Additional time may be required to transfer the resin/hardener/nucleation agent mixture into a mould, or spread, spray or otherwise apply the mixture to a surface, which may be a surface within a heat battery.

In a preferred embodiment a resin and hardener combination are selected such that a fully hardened piece in more than 1 minute, more than 5 minutes, more than 20 minutes, more than 1 hour, more than 3 hours or more than 6 hours.

Heating may be applied to the resin during the hardening time period to increase the speed of the hardening process. In a preferred embodiment, the resin/hardener/nucleation agent mixture is applied to a heat exchanger surface and the heat exchanger is heated to rapidly harden the resin/hardener/nucleation agent mixture into the nucleation agent piece, which is then located on the heat exchanger surface. Heat, moisture and/or light may be optionally applied in a similar manner to rapidly harden the resin/hardener/nucleation agent mixture.

FIG. 2 shows a schematic representation of the process used to prepare nucleation agent pieces. The processing method described in FIG. 2 is exemplary only and is included for descriptive purposes only, for instance the exact order of combination of components and their relative weight loadings may be altered.

In an embodiment, the method may comprise combining between about 1 and about 90 wt. % of the nucleation agent, between about 5 and about 75 wt. % of the resin, and between about 2 and about 50 wt. % of the resin hardener.

By way of non-limiting example, pieces of disodium phosphate and epoxy may be applied as a nucleation agent for a PCM of sodium acetate trihydrate. Disodium phosphate may be added to a two-part epoxy mix in the following ratios:
34 wt. % disodium phosphate
33 wt. % epoxy resin
33 wt. % epoxy hardener.

The materials may then be mixed until fully homogeneous and then allowed to harden for around 24 hours, after which the material became a single continuous solid. It was found that altering the composition between the following ranges would result in a macroscopic epoxy-nucleation agent piece comprising:
Between about 1 and 90 wt. % of disodium phosphate, and
Between about 10 and 99 wt. % of an epoxy, wherein the epoxy was formed from equal amounts of epoxy resin precursor and hardener (i.e. a 50:50 mass ratio).

Various commercial epoxy resins and hardeners are available, and as such the resin:hardener ratio may vary considerably. Commonly the resin:hardener mass ratio may be 50:50, as in the above example, however the ratio may be between 50:50 and 99:1.

The nucleation agent may be blended with either the resin prepolymer or the resin hardener, and then adding the remaining component (e.g. resin or hardener) to produce the hardened resin-nucleation agent composite (nucleation agent piece). It is also possible to mix the resin and hardener and then combine said mixture with the nucleation agent, should the hardening time be long enough that the resin/hardener mixture is still liquid or substantially liquid at the time that the nucleation agent is added. It is preferable where the nucleation agent loading is high (i.e. above about 30 wt. %) to mix the resin prepolymer and resin hardener together and then add the nucleation agent material before hardening takes place. Typically, hardened resins may be formulated such that the hardening process takes place over minutes to around 1-2 days, and as such the window in which the nucleation agent may be added, which must be before hardening occurs, may be short (e.g. a few minutes), to long (e.g. 10s of hours). In a preferred embodiment a resin and hardener combination are selected such that a fully hardened piece in more than 1 minute, more than 5 minutes, more than 20 minutes, more than 1 hour, more than 3 hours or more than 6 hours.

The nucleation agent may be added to:
between about 5 and 75 wt. % of a resin
and/or
between about 2 and 50 wt. % of a resin hardener
   Where the remaining mass comprises the nucleation agent, and
   The parts comprising resin and hardener are not combined,
   and then the two parts stored separately until a time when the components are mixed to produce the nucleation agent-hardened resin composite.

This allows the means of producing a hardened resin-nucleation agent composite to be separated from the time of producing any other PCM related components, i.e. the production becomes decoupled in time. This allows a degree of flexibility in the production of a PCM or PCM system which comprises a hardened resin-nucleation agent composite. It also allows the process to be carried out off-site, or remotely, or at a place different to that where the components are prepared, necessitating only that the two components be mixed in the correct ratio and applied in the correct manner in a secondary location.

In an embodiment of the present disclosure, a method of preparing a nucleation agent piece comprises:
combining the following;
between about 1 and 90 wt. % of one or more nucleation agent,
with,
between about 5 and 75 wt. % of an epoxy resin,
and
between about 2 and 50 wt. % of an epoxy resin hardener,
   mixing to form a mixture,
   and allowing the mixture to harden.

The resin may be allowed to harden in a mould, which is preferably a silicone mould, giving a variety of different possible shapes. However, the hardened resin-nucleation agent pieces may also be allowed to harden in situ, i.e. in the PCM or substantially in the PCM. In this scenario, resin components and loose nucleation agent are blended and then added to the PCM or heat battery comprising a PCM. This may be carried out while the PCM is in its molten state, is above its melting point or is substantially above its melting point. The resin-nucleation agent mixture then hardens in situ, giving the hardened resin-nucleation agent composite.

This necessitates that the PCM is immiscible with the resin/nucleation agent mixture. Thus, it is preferred that the PCM comprises a salt and water, as the resin, and, where present, the hardening agent tend to be organic in nature. Therefore, when combined the resin-nucleation agent mixture form droplets in the PCM, which then over time harden to give the hardened resin-nucleation agent composite pieces. This method may also be used to retroactively apply said pieces to a pre-prepared PCM or heat battery apparatus.

Different resin materials may be used to form the hardened resin matrix in which the nucleation agent is located, however 2-part resin/hardener matrices are preferred. In general, two part resin/hardener matrices have the benefit during preparation that there is little chance of unwanted hardening. If the two components are kept separately and have no contact prior to use, they remain in their useable form and can be applied as disclosed herein without issue. The nucleation agent may therefore be blended with one or more parts of a multi-part hardened resin precursor system and stored in the same way without risk of unwanted hardening. Single part hardened resin precursors have the potential to begin their hardening process prematurely, especially when combined with the nucleation agent, which may react, harbour an initiator such as moisture, produce an exotherm which may initiate the reaction, or necessitate the resin precursor be exposed to light or another initiating condition before the hardening process is desired. Furthermore, 2-part resin/hardener systems typically have longer shelf lives and may handle long term storage or long transit times better.

The hardened resin may be an epoxy, due in part to their ease of handling and safety characteristics. Resins may have toxic precursors or involve solvents or other additives which are degassed during preparation. Of particular concern is styrene, a toxic, flammable liquid, is produced as a vapour during the drying process of some resins, and should be avoided. Conversely, epoxy precursor resins and hardeners are relatively benign, are cheap and readily available and produce a hard wearing, thermally stable and inert matrix in which nucleation agents may be located. Two-part epoxies are therefore preferred components in the formation of the hardened resin-nucleation agent composites disclosed herein.

It is disclosed herein that the loading of a nucleation agent within a PCM composition comprising a nucleation agent and a PCM may be reduced when using a hardened resin-nucleation agent composite. It has been found by the inventors that lower loadings of nucleation agent may be used when it is bound within the hardened resin. In other words, if a threshold mass loading of a loose nucleation agent (e.g. nucleation agent in the form of powder, granules, flakes etc.) must be used to ensure nucleation occurs, then binding the nucleation agent in a hardened resin will result in this threshold being reduced. For example, if 2 wt. % of a loose nucleation agent is required to ensure the PCM reliably nucleates from its molten state, less than 2 wt. % of nucleation agent material is required when that material is bound within a hardened resin matrix. The overall loading of the nucleation agent in the PCM in this scenario is less than 2 wt. %. This reduction in nucleation agent content may give the following benefits:
lowered cost associated with the nucleation agent material,
lowered system weight,
lowered system volume,
increased energy storage if the same weight and volume is used, and the free weight and volume instead used as the PCM
lowered risk of potentially hazardous dust/spillage formation

Without wishing to be bound by any particular theory, it is proposed that a loose powder of a nucleation agent is inefficient in its application, and therefore larger loadings are required. This may be due to agglomeration, disadvantageous changes to the surface chemistry (e.g. hydration and/or dehydration), disadvantageous recrystallisation or dissolution in the latent heat storage material, or poor location within the PCM. Combination of the nucleation agent with a hardened resin may overcome these issues as the nucleation agent is located in an immobilised matrix, cannot agglomerate, and may be protected from disadvantageous deactivation processes (e.g. hydration, dehydration, recrystallisation, degradation, dissolution) by the presence of the hardened resin in which it is located.

The following disclosures detail various methods of use of hardened resin-nucleation agent composites in the preparation and usage of phase change materials and energy storage systems comprising phase change materials.

Use of hardened resin-nucleation agent composite pieces is disclosed herein as a way by which the preparation of a PCM composition may be reduced in complexity. Where operators are non-technical, it is preferable to avoid the need for precise weighing and measuring, and having macroscopic, form stabilised additive pieces which may be added simplifies and quickens the process considerably. In this scenario, rather than weighing additives in the correct ratios to each other and the PCM, the PCM composition can be produced simply by counting hardened resin-nucleation agent composite pieces and combining them with the other PCM components.

The mass and volume of the hardened resin-nucleation agent composites may also be lower than that required if a loose (e.g. powder, flake, granule or other) form of one or more nucleation agents are required. Thus, where accuracy is required from operators preparing the PCM, accurate measurements may only be required on a smaller scale when using a hardened resin-nucleation agent composite. In other words, operators may need to accurately measure resin and/or hardener and/or the nucleation agent and control the mixing thereof, but this may be only required on a smaller scale than when using the equivalent loose form of the nucleation agent.

The present disclosure provides a heat battery device comprising:
a container;
a phase change material (PCM) located in the container;
one or a plurality of nucleation agent piece(s) as described herein located in the container; and
one or more means for the addition and removal of heat from the heat battery device located in the container.

The one or more means for the addition and removal of heat from the heat battery device may be one or more heat exchangers, heat pipes, heat spreaders, thermoelectric devices, heat sinks, or other means of heating or cooling the PCM.

The use of hardened resin-nucleation agent composite pieces for controlling the nucleation regime within the PCM is disclosed herein. It has also been found by the inventors that the performance of such a PCM can be dramatically affected by where the nucleation agent(s) pieces are located in the PCM, and therefore that controlling this parameter is beneficial to the PCM's, and thereby a heat battery comprising said PCM's performance.

When a nucleation agent or agent(s) is/are present, crystal growth proceeds from said agent(s) on cooling the molten PCM below its crystallisation temperature. Typically, nucleation agents tend to concentrate in a certain area of a PCM container, and therefore crystallisation proceeds from this area alone. This causes a crystal growth front to move away from the nucleation agent. For instance, if a nucleation agent is denser than the PCM upon which it acts, it will tend to sink to the bottom of the PCM container, and when crystallisation occurs, a crystal growth front proceeds upwards. Where a crystal front moves through a PCM container, the PCM far from the nucleation agent will not crystallise until the crystal growth front reaches it. This material will thereby not nucleate immediately, and therefore will continue subcooling and not contribute to the thermal output of the device until the crystal growth front reaches it. Locating the nucleation agent in a plurality of points or areas within a PCM container alleviates or obviates this problem as there is the potential for a plurality of crystal growth fronts to proceed simultaneously in the heat battery and thus lessened bulk subcooling.

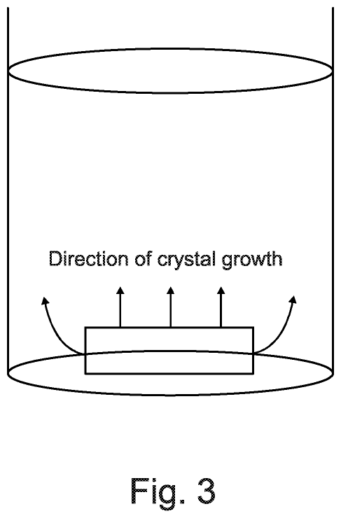

FIG. 3 shows crystal growth in a sample of PCM from a nucleation agent piece located at the bottom of the container. Crystal growth from the nucleation agent block upward is demonstrated, with crystals of the PCM progressing from the nucleation agent upward into the liquid bulk.

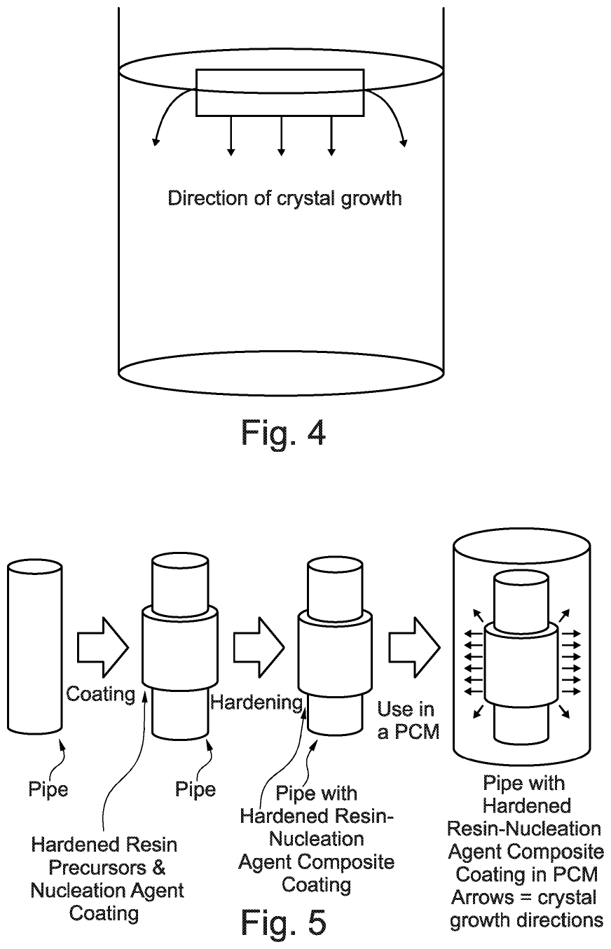

The crystallisation regime control may be demonstrated by producing a nucleation agent piece which floats in the PCM, or is held in a specific locale (e.g. by being stuck to the top or walls of the container, or to internal pipework or heat exchanger apparatus). FIG. 4 shows crystal growth of a PCM beginning from a nucleation agent piece located at the top of the container. Situating the nucleation agent here causes the crystal growth front to proceed downwards. To control the location of an epoxy-nucleation agent piece, density modification agents such as hollow glass bubbles or other low density media such as air pockets may be added to the hardened resin-nucleation agent piece(s), or the piece(s) may be placed on or adhered to one or more surface which is, at least partially, in contact with the PCM.

Furthermore, depending on the identity of the PCM, crystal growth occurs at different rates. Where the crystal growth is fast, the thermal power of the system may be limited only by the rate at which heat can be extracted from the system, however if crystal growth is slow this may limit thermal power. As achieving high thermal power is key in producing a high performance PCM device, it is therefore beneficial for the crystal growth to be optimised within the device container. To maximise thermal power, crystallisation should be initiated from a plurality of locales, thus reducing or removing any limitation of the thermal power by crystal growth rate.

It is therefore beneficial to control nucleation and thereby the crystal growth regime in a PCM device. Nucleation agent(s) may be dispersed evenly throughout a bulk of PCM, and therefore when cooled below its thermodynamic phase transition temperature, all of the PCM is in close proximity to the nucleation agent. The effect of this improvement is dramatic where the rate of crystal growth is low compared to the available power of the PCM system. However, while a nucleation agent or agent(s) may be dispersed well initially, over time this is unlikely to be the case. Forming of one or more nucleation agent(s) into macroscopic pieces as disclosed herein which can be located within the PCM allows control over the position of said nucleation agent(s) and thereby ensures that nucleation and subsequent crystal growth can occur in an optimal regime for a prolonged period of use.

Ideally in a PCM system, the area where the nucleation agent(s) is/are located is the first area to cool to the thermodynamic melting/freezing temperature of the PCM, and therefore nucleation and crystallisation occurs at the highest thermodynamically allowed temperature, resulting in the greatest thermal output. For example, if a PCM melts at 50° C., a nucleation agent should be located such that on cooling the PCM the first area of the PCM to be cooled to 50° C. is in contact with, or in close proximity to, the nucleation agent. Adhering the nucleation agent piece to a surface which experiences cooling by, by way of non-limiting examples, spreading, pouring spraying or otherwise applying the mixture onto said surface is disclosed as a preferred method of reducing subcooling of a PCM in the vicinity of said surface. Contacting the nucleation agent piece with such a surface which provides cooling ensures that nucleation occurs at the earliest possible point during cooling of the PCM, and thus subcooling is minimised.

In an embodiment of the present disclosure, the hardened resin-nucleation agent composite may be located in regions where the rate of heat transfer out of the system is high, such as a heat exchanger apparatus, heat bridge, heat pipe, thermoelectric device or the walls of the PCM container. In this regime, the location of the nucleation agent is distributed to match heat transfer out of the PCM device (i.e. cooling). More preferably, the hardened resin-nucleation agent composite piece is located on the surface of a component via which cooling is introduced into the system, such as a heat exchanger apparatus, heat bridge, heat pipe, thermoelectric device or the walls of the PCM container.

It is an embodiment of the present disclosure that the hardened resin-nucleation agent composite (nucleation agent piece) is located on, near or substantially near a heat exchanger apparatus, particularly where the heat exchanger apparatus supplies cooling to the system. This may be pipework, optionally in combination with further heat spreading means, which supplies cooling via a heat transfer fluid (e.g. cold water, glycol, or thermal oil).

The hardened resin may be used to locate the nucleation agent where is beneficial to the system performance, i.e. the benefit of being usable to adhere the nucleation agent particles in a specific location which may be an area of high thermal transport. This may be achieved by coating, pouring, spraying or otherwise applying the blended resin precursors and nucleation agent material onto a surface prior to allowing the mixture to harden. After hardening a layer of hardened resin-nucleation agent is left on the surface, and thereby the active nucleation agent is held in position on the chosen surface. Using a pipe by way of non-limiting example, through which a cooling fluid may be flowed, FIG. 5 shows this process being applied. In place of the pipe used in FIG. 5, the same process may be applied to, by way of further non-limiting example, a series of pipes, one or more heat pipes, pipework as part of the heat exchanger, fins and/or heat spreaders which may form part of a heat exchanger and/or the container walls.

For example, in a PCM container with a heat exchanger within it and an electrical heating element, it is preferable to have the heating element at the base to allow for heat to transfer upwards into the bulk PCM (thus charging, i.e. melting, it), and to maximise exergy it is preferable to have opposite heat flow direction for charging and discharging, therefor the heat exchanger is configured to have coolant flow pathway that results in a top-down discharge configuration (i.e. cooling is applied via the heat exchanger with coolant being introduced into the system from the top of the heat exchanger). This approach maximises the differential temperature between the top and the bottom of the PCM container, thus generates a benefit to the energy storage capacity. However, for this to be effective the PCM nucleator is required to be near the cold coolant inlet, i.e. the top of the PCM container, as this is the area that gets first cooled when discharged. In some use cases, the base of the PCM container may never get below the thermodynamic PCM melting point temperature (due to partial discharges and heating from the base of the PCM container). If the heterogenous nucleator is denser than the PCM then this is problematic as it will not play an active role in enabling nucleation of the PCM, as the region in which it is located is never cold enough to allow nucleation. This regime would likely cause severe subcooling or no nucleation at all, effectively preventing the apparatus from dispensing its full thermal output.

It is an embodiment of the present disclosure that the hardened resin-nucleation agent composite is located in an area of the heat battery device to which is applied cooling when heat is required to be released from the heat battery. This may involve one or more discrete pieces of hardened resin-nucleation agent composite being placed without adhesion into said location or may involve use of a process such as that that is described in FIG. 5, wherein the composite is coated directly onto a surface in said location.

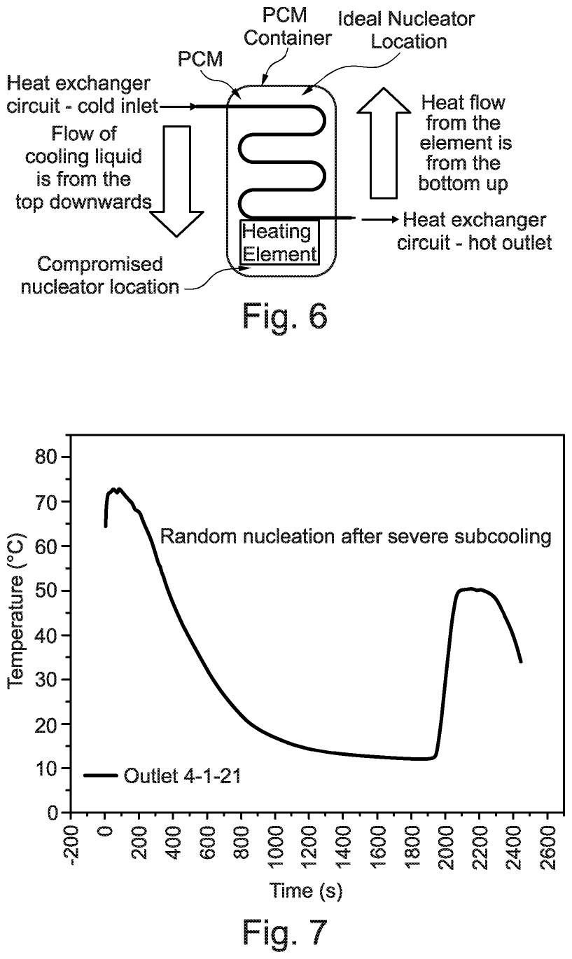

It is beneficial to the operation of a heat battery that nucleation occurs at the maximum temperature possible (i.e. the phase transition temperature of the PCM). Therefore, it is preferable to locate the nucleation agent in a part of the heat battery which experiences the greatest cooling effect. Thus, when the PCM cools, the area with the nucleation agent is the first to cool to the thermodynamic phase transition temperature, and therefore will nucleate at the earliest possible point. For example, if cooling is introduced into the top of the PCM (e.g. by flowing cooling liquid through a heat exchanger where the inlet is located toward the top of the battery), then the most rapid cooling will be experienced by the PCM at the top of the battery. In this regime, locating the nucleation agent at the top of the PCM is beneficial. Using a loose powder would result in the nucleation agent sinking according to gravity, and then causing nucleation to occur only when the region at the bottom of the cell reached the phase transition temperature. This results in a slow response from the heat battery, and subcooling in the top of the heat battery. Therefore, using a hardened resin-nucleation agent piece which is affixed to or placed in or on a supporting structure, which may be internal componentry or the container walls is beneficial. FIG. 6 shows a schematic representation of this effect.

The resin precursor(s)/nucleation agent mixture may be applied by painting, spraying, dropping, dip-coating, rolling, blade casting, spin coating or otherwise applying the mixture to the chosen surface before hardening occurs in place.

It is preferred to use methods where a thin layer (less than 5 mm) may be produced. More preferably, a layer of less than 2 mm may be applied. More preferably still, a layer of less than 0.5 mm may be applied. As the nucleation agent material at the surface is that which acts to nucleate the PCM, it is advantageous to maximise the surface area of the hardened resin-nucleation agent composite, and thus a thin layer is preferred. Herein a layer may be taken to mean any shape of a low height relative to its width and breadth, which is applied to a surface. Droplets may also be applied, by, for example, dropping or spraying onto one or more surfaces of high heat transmission.

The hardened resin-nucleation agent composite may be applied to, and subsequently located on, or in the vicinity of, one or more of the following parts of one or more heat exchanger(s):
on the surface of one or more fins,
on the surface of one or more manifolds,
on the surface of one or more heat exchanger cooling inlet pipes.

Herein a fin may be described as a heat spreader, which may be interfacing with one or more pipes which supply heating and/or cooling to the PCM in which it is in contact. For example the heat exchanger may be a fin-tube heat exchanger, which is located within the PCM container and is submerged or partially submerged in the PCM. The hardened resin-nucleation agent composite piece may be located on said fin comprising part of the fin-tube heat exchanger which is in contact with the PCM.

Herein a manifold is defined as a part of the heat exchanger which splits or combines the flow of heating and/or cooling fluid passing through the heat exchanger into or from a plurality of smaller pipes into a smaller number of larger pipes. For example, one large pipe which has a plurality of ports which allow fluid transfer to an array of smaller pipes, which may form part of the heat exchanger, preferably intersecting with fins to form a fin-tube heat exchanger. Hence the manifold may be the main inlet of cooling to the heat exchanger, and thus it may be beneficial to locate the hardened resin-nucleation agent composite on such a manifold.

Preferably the hardened resin-nucleation agent composite is formed as a small thin layer or droplet located on one or more heat conductive surfaces, which may apply cooling into the PCM. A plurality of pieces of the hardened resin-nucleation agent composite may be applied within a PCM, or heat battery device comprising a PCM.

Where a heat battery comprises one or more cooling surfaces (e.g. inlets supplying cold, cooling devices, thermally conductive pathways to areas colder than the PCM), a hardened resin-nucleation agent composite piece may be located in a plurality of locations. Preferably the hardened resin-nucleation agent composite piece may be located in the location which has a high thermal transmission out of the system, i.e. the location within the PCM which becomes coldest fastest when cooling is applied. However, it may be beneficial to locate the hardened resin-nucleation agent pieces in a plurality of locales. Where a PCM crystallises slowly, for example due to low crystal growth rates and/or high viscosity, the thermal output of the system is limited if the PCM nucleates from one or a small number of locations. As the thermal power is proportional to the mass of crystals growing, a single or a few nucleation sites in a large volume will not produce a high thermal power. Thus, while it is preferred to ensure that nucleation occurs at the first opportunity by locating the hardened resin-nucleation agent composite in the area of the PCM which is first to cool below the phase transition temperature of the PCM on cooling the system, including further composite pieces in other locales may be beneficial, especially if the PCM is slow to crystallise.

A plurality of hardened resin-nucleation agent composite pieces may be located on one or more of the following:
on the surface of one or more fins,
on the surface of one or more manifolds,
on the surface of one or more heat exchanger cooling inlet pipes
   where the hardened resin-nucleation agent composite pieces are arranged in a distributed manner, i.e. where each pieces is separated in space from one another.

The pieces may be less than 50 cm, less than 20 cm, less than 10 cm, less than 5 cm or less than 2 cm apart from another piece.

The plurality of resin-nucleation agent composite pieces may be distributed in a regular fashion throughout the PCM or within a volume of the PCM.

Preferably the plurality of resin-nucleation agent composite pieces may be arranged such that each piece is located on the vertex points conforming to a regular, and optionally repeatable, cubic or square grid on the surface of:
on the surface of one or more fins,
on the surface of one or more manifolds,
on the surface of one or more heat exchanger cooling inlet pipes.

Preferably the plurality of resin-nucleation agent composite pieces may be arranged such that each piece is located on the vertex points conforming to a regular, and optionally repeatable, cubic or square grid on the surface of:
on the surface of one or more fins,
on the surface of one or more manifolds,
on the surface of one or more heat exchanger cooling inlet pipes, wherein each vertex is less than 50 cm, less than 20 cm, less than 10 cm, less than 5 cm or less than 2 cm apart.

A further aspect and benefit of the present invention is the location of a hardened resin-nucleation agent within a PCM in such a way that improves the PCM's cycle stability. It is typical for PCMs requiring nucleation agents to respond to a small number of materials, and changes to these materials may render them inactive. By way of non-limiting example, it is known to the inventors that disodium phosphate dihydrate (Na₂HPO₄·2H₂O) is a nucleation agent for sodium acetate trihydrate (NaOAc·3H₂O), but if changed to a different hydrate of disodium phosphate (i.e. the anhydrous, heptahydrate and/or dodecahydrate), nucleation may not go ahead. Therefore, stabilisation of a working nucleation agent against any change is key in producing a working PCM system. Such changes may be hydration or dehydration as discussed, but also for example chemical reaction, phase change, polymorph change, morphological change or photochemical reaction. These processes which may inactivate the nucleation agent could be driven by the conditions present in the PCM, however these conditions may not be homogeneous throughout the PCM bulk. For instance, if a photochemical process deactivates a nucleation agent, such deactivation would be most strongly observed in the PCM that is exposed to light.

Therefore, where a nucleation agent undergoes an unwanted inactivation process driven by certain conditions, it is beneficial to retain the nucleation agent in a location where said conditions are not in effect or are minimised. In continuation of the previous example of a photosensitive nucleation agent, holding the nucleation agent in a dark area of the PCM bulk would decrease the inactivation of the nucleation agent, and therefore improve the reliability of nucleation of the PCM as a whole. A further commonly encountered advantage of nucleation agent deactivation is thermal degradation. In a PCM containing device, heat is often applied unevenly, which may cause extremes of temperature in the locale of the nucleation agent(s) if not designed against. Where nucleation agent(s) is/are thermally sensitive, such conditions can lead to deactivation. Location of hardened resin-nucleation agent composite pieces in a region that remains within a specific temperature range is therefore beneficial.

It is known to the inventors that hydrated salts which act as nucleators may dehydrate at high temperatures, causing them to cease effectively nucleating. For example, disodium phosphate dihydrate will dehydrate at high temperatures and cease to nucleate effectively for sodium acetate trihydrate. Typically, an immersed electric element will be situated at the bottom of the heat battery device, to take advantage of convective heat transfer throughout the PCM. Thus, if a loose nucleation agent powder is used, it will sink through the PCM and settle near the element, which may operate at a temperature which is degrading to the nucleation agent. Therefore, it is beneficial to use an immobilised hardened resin-nucleation agent composite piece which can be adhered to or placed on/in a supporting structure in a location where the high temperature of the electric element is not in effect (e.g. towards the top of the PCM container or in a region where cooling is in effect), and thereby retain the nucleation agent's activity.

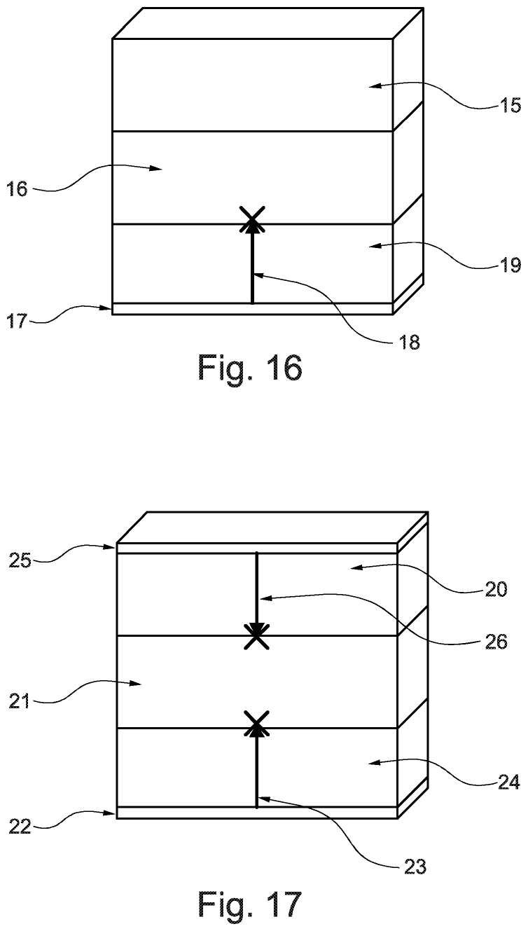

It is a further benefit of the ability to locate one or more nucleation agent piece(s) within a PCM and/or heat battery apparatus comprising a PCM that nucleation may proceed in a distributed, homogeneous, or even manner throughout the PCM volume in situations where the PCM temperature is not evenly distributed, i.e. there is one or more temperature zones, gradients or hot or cold spots in the PCM. Where a PCM exhibits a region of temperature higher than that of the melting point of the PCM, this region will not allow crystals which are growing elsewhere to enter this zone. Any crystals which do contact this region of temperature greater than the melting point of the PCM themselves melt, and therefore cannot propagate the crystal growth front into this region until it is cooled below the PCM melting temperature. Said zone of high temperature may even block the propagation of the crystal growth front if the zone separates two regions where the temperature is low enough to allow crystal growth. Nucleation in one low temperature zone cannot produce nucleation in the other as crystals cannot traverse the high temperature zone. This is shown schematically in FIG. 16. In FIG. 16, two regions of a PCM (15 & 19) with a temperature lower than that of the melting temperature of the PCM are separated by a region of the PCM (16) which has a temperature higher than that of the melting temperature of the PCM. Nucleation from a region of the PCM (17) produces a crystal growth front moving generally away from the nucleation site as indicated by arrow 18. However, once this crystal growth front reaches the PCM region (16) with a temperature higher than the melting point of the PCM, it can proceed no further, and thus the crystal growth (and therefore latent heat release) stops until the high temperature PCM zone (16) is cooled below the melting point of the PCM. Thus the PCM zone (15), which has a temperature below the melting point of the PCM and therefore is thermodynamically allowed to crystallise is prevented from doing so until the PCM zone 16 is cooled sufficiently. PCM zone 15 is therefore not able to contribute its latent heat to the system initially, reducing the thermal power output of the system. Location of a plurality of nucleation agent pieces within a PCM may allow efficient freezing of the bulk of the PCM due to the nucleation beginning at a plurality of points, regions, volumes or areas, which may be separated by thermal zones which would otherwise not allow the propagation of a crystal front. This is shown schematically in FIG. 17.

In FIG. 17, two regions of a PCM (20 & 24) with a temperature lower than that of the melting temperature of the PCM are separated by a region of the PCM (21) which has a temperature higher than that of the melting temperature of the PCM. Nucleation from a region of the PCM (22) produces a crystal growth front moving generally away from the nucleation site as indicated by arrow 23. Nucleation from a region of the PCM (25) produces a crystal growth front moving generally away from the nucleation site as indicated by arrow 26. Once this crystal growth front reaches the PCM region (16) with a temperature higher than the melting point of the PCM, it can proceed no further, and thus the crystal growth (and therefore latent heat release) stops until the high temperature PCM zone (21) is cooled below the melting point of the PCM. However, in comparison to the scenario detailed in FIG. 16, a higher proportion of the PCM has been crystallised when nucleation starts in a plurality of points (in this non-limiting example, the bottom and the top of the PCM). Thus, despite a part of the PCM being at a temperature too high to allow crystallisation, the parts of the PCM which are cool enough to allow crystallisation are able to nucleate and release their latent heat due to the presence of a plurality of separated nucleation points, zones, areas or regions. The blocking effect on crystal growth of a high temperature region or zone has been overcome. Therefore, locating a plurality of nucleation agent pieces from which nucleation can occur and crystal growth begin is beneficial to the reliable, homogeneous production of high-power thermal energy.

It will be clear to those of skill in the art that the described embodiments of the present disclosure are merely exemplary, and that various modifications and improvements thereto may be made without departing from the scope of the present disclosure. For example, any suitable range of concentrations of the materials and components described above may be used.

### EXPERIMENTAL EXAMPLES

The present disclosure will be described in more detail with reference to Examples. The present disclosure is not limited to the following Examples.

### Example 1

Nucleation agent pieces were prepared in the form of discs by mixing amounts of a nucleation agent (in this example disodium phosphate, DSP) with an epoxy resin and hardening agent in the mass ratio of 2:1. Amounts of DSP between about 25 wt. % and 75 wt. % were mixed into the resin and then the hardening agent was added, and the mixture poured into cylindrical silicone moulds. Blanks containing no DSP were also prepared in the same way, but without the addition of DSP. The hardening process took place over the course of around 24 hours at room temperature. The discs were then removed from the moulds and placed in samples of a PCM (in this example sodium acetate trihydrate) and cycled by heating to 70° C. until fully molten and then cooling to room temperature. 10 repeats of each sample were carried out to gauge the statistical significance of the results obtained. A blank set of samples containing no nucleation agent was ran in parallel. To provide a fair comparison, samples which did not nucleate were manually seeded with sodium acetate trihydrate crystals and allowed to cool before remelting—this allows for the propensity of the epoxy to retain seed crystals within its structure to be tested. The performance of the discs was assessed by the percentage of samples of each DSP loading which crystallised on cooling, the results of which are shown in Table 1.

TABLE 1

| | % of samples in which nucleation was observed | | | | | |
|---|---|---|---|---|---|---|
| | No | | 75 wt. % | 50 wt. % | 20 wt. % | 10 wt. % |
| | Nucleation | Blank | DSP | DSP | DSP | DSP |
| Cycle | Agent | Epoxy | Composite | Composite | Composite | Composite |
| 1 | 0% | 0% | 70% | 50% | 10% | 0% |
| 2 | 0% | 0% | 100% | 90% | 20% | 0% |
| 3 | 0% | 0% | 100% | 100% | 80% | 40% |
| 4 | 0% | 0% | 100% | 100% | 70% | 40% |
| 5 | 0% | 0% | 100% | 100% | 60% | 40% |
| 6 | 0% | 0% | 100% | 100% | 80% | 60% |
| 7 | 0% | 0% | 100% | 100% | 70% | 60% |
| 8 | 0% | 0% | 100% | 100% | 80% | 80% |
| 9 | 0% | 0% | 100% | 100% | 90% | 60% |
| 10 | 0% | 0% | 100% | 100% | 70% | 70% |

All of the DSP composites (pieces) produced superior nucleation performance than the blanks, where no nucleation was observed in any sample over 10 thermal cycles. Higher DSP loadings were observed to generally produce higher nucleation percentages. There was also observed to be an increase in the performance of each nucleation agent piece as the number of thermal cycles performed increased, this is suggested to be due to the recrystallisation of DSP in contact with the PCM to give the dihydrate form of DSP, which is known to the inventors as the active nucleation agent for sodium acetate trihydrate.

### Example 2

Nucleation agent pieces were prepared in the form of discs by mixing amounts of a nucleation agent (in this example disodium phosphate, DSP) with an epoxy resin and hardening agent in the mass ratio of 3:2:1, i.e. a 50 wt. % loading of DSP in the final hardened resin. Multiple discs were prepared, including blanks containing no DSP. These samples were placed in containers with sodium acetate trihydrate and held at 70° C. for 24 hours. The samples were then allowed to cool to room temperature and the nucleation performance measured according to the number of samples which were observed to nucleate on cooling. To provide a fair comparison, samples which did not nucleate were manually seeded with sodium acetate trihydrate crystals and allowed to cool before continuing the test—this allows for the propensity of the epoxy to retain seed crystals within its structure to be tested. The samples were then remelted and the molten sodium acetate trihydrate removed. The samples were then rinsed with fresh molten sodium acetate trihydrate 3 times to remove any DSP which may have desorbed from the hardened resin matrix. A fresh sample of molten sodium acetate trihydrate was then added and the composite discs were held in this solution for a further 24 hours before cooling to room temperature. The samples were then cooled to room temperature once again and the nucleation performance ascertained according to the number of samples which nucleated on cooling. This process was repeated once again. The results of this process are shown in Table 2.

TABLE 2

% of samples in which nucleation was observed

| Cycle | Blank Epoxy | 50 wt. % DSP in epoxy composite |
|---|---|---|
| 1 | 0% | 90% |

Rinsing with molten sodium acetate trihydrate

| | | |
|---|---|---|
| 2 | 0% | 90% |

Rinsing with molten sodium acetate trihydrate

| | | |
|---|---|---|
| 3 | 0% | 100% |

Thereby it is shown that the nucleation agent contained within a hardened resin is responsible for nucleation, and not any material which may have been shed from the composite piece and remained in the solution as this would be removed by the rinsing process described. It also demonstrates that the nucleation agent may be held within the hardened resin despite multiple melt-freeze cycles and also despite some slight solubility of the nucleation agent in the PCM (disodium phosphate is slightly soluble in sodium acetate trihydrate).

### Example 3

Nucleation agent pieces were prepared in the form of discs by mixing various amounts of a nucleation agent (in this example strontium chloride hexahydrate, SCH) with an epoxy resin and hardening agent which were mixed in the mass ratio of 2:1. Amounts of SCH between about 25 wt. % and 75 wt. % were mixed into the mixture of epoxy resin and hardener. The hardening process took place over the course of around 24 hours at room temperature. The discs were then removed from the moulds and placed in samples of a PCM (in this example calcium chloride hexahydrate) and cycled by heating to 35° C. until fully molten and then cooling to about 2-5° C. A blank set of samples containing no nucleation agent was ran in parallel. Nucleation was observed in the samples comprising the SCH-hardened epoxy composites (pieces) within about 10 minutes of cooling the samples, whereas nucleation was observed more than an hour later in the blank epoxy and no nucleation agent control samples.

Thus, the SCH-hardened resin composite had reduced subcooling and improved nucleation in the PCM, where the blank hardened epoxy and sample without any nucleation agent had not. Furthermore, the nucleation of the blank hardened epoxy control and the samples lacking any nucleation agent were observed to nucleate at similar times, indicating that the resin matrix was not itself acting as a nucleation agent. All samples were then rinsed with molten SCH at about 35° C. and the test repeated, showing the same nucleation characteristics of each sample (i.e. rapid nucleation only in the SCH-hardened resin containing samples).

### Example 4

Nucleation agent pieces were prepared in the form of rods by mixing amounts of nucleation agent (in this example anhydrous calcium nitrate, ACN) with an epoxy resin and hardening agent which were mixed in the mass ratio of 2:1. The loading of ACN was approximately 40 wt. %, with the epoxy resin and hardener comprising the other about 60 wt. %. The nucleation agent piece rod was inserted into a bottle containing molten calcium nitrate tetrahydrate and sealed closed. Equivalent systems containing blank hardened epoxy rods and no nucleation agent at all were also prepared. The containers were then cooled to about 2-5° C. and a seed crystal of calcium nitrate tetrahydrate added to each. The samples were then heated to 70° C. until each was fully molten. The samples were then cooled to about 30° C. Crystallisation was observed only in the sample containing the anhydrous calcium nitrate-hardened epoxy composite rod, and not in the blanks. Further cooling of the blanks to 2-5° C. was found to not result in nucleation, which could only be induced by the addition of a seed crystal. In this case, and without wishing to be bound by any particular theory, the inventors suggest that the initial cooling from a molten state allows the anhydrous calcium nitrate present at the surface of the hardened resin matrix to recrystallise as its tetrahydrate form, which then initiates nucleation. The blanks, comprising no anhydrous calcium nitrate cannot form this recrystallised calcium nitrate tetrahydrate and thus do not nucleate.

### Example 5

Nucleation agent pieces were prepared in the form of discs by mixing amounts of a nucleation agent (in this example disodium phosphate, DSP) with an epoxy resin and hardening agent in the mass ratio of 3:2:1, i.e a 50 wt. % loading of DSP in the final hardened resin matrix. Multiple discs were prepared, including blanks containing no DSP. These samples were placed in containers with sodium acetate trihydrate and held at 70° C. for 6 months. Once per month, the samples were removed from the oven and allowed to cool to room temperature to observe their nucleation performance. To provide a fair comparison, samples which did not nucleate were manually seeded with sodium acetate trihydrate crystals and allowed to cool before continuing the test—this allows for the propensity of the epoxy to retain seed crystals within its structure to be tested. After each cooling cycle, the sodium acetate trihydrate was removed, the samples were then rinsed with molten sodium acetate trihydrate and then finally a fresh sample of molten sodium acetate trihydrate was added to each sample. The results of this are shown in Table 3.

TABLE 3

| | % of samples which nucleated on cooling | | | | | | | | |
|---|---|---|---|---|---|---|---|---|---|
| | Month | Month | Month | Month | Month | Month | Month | Month | Month |
| Sample | 1 | 2 | 3 | 4 | 5 | 6 | 9 | 12 | 18 |
| No | 0 | 0 | 0 | 0 | 0 | 0 | 0 | 0 | 0 |
| nucleation | | | | | | | | | |
| agent | | | | | | | | | |
| Blank | 0 | 0 | 0 | 0 | 0 | 0 | 0 | 0 | 0 |
| epoxy | | | | | | | | | |
| Epoxy- | 80 | 100 | 100 | 100 | 80 | 100 | 100 | 100 | 100 |
| DSP | | | | | | | | | |
| composite | | | | | | | | | |

Thus, the potential for good retention of the performance of the hardened resin-nucleation agent composite (piece) can be demonstrated. Each sample containing the active nucleation agent DSP nucleated well over the 18 months tested, compared to the blanks where no nucleation was observed.

### Example 6

Nucleation agent pieces were prepared in the form of discs by mixing amounts of a nucleation agent (in this case TiO₂) with various different resin materials and their corresponding hardeners (where present). Various compositions are shown in Table 4.

TABLE 4

| | | Resin | | Hardener | |
|---|---|---|---|---|---|
| | | Loading | Hardener | Loading | Nucleator |
| Resin | Resin Brand | (wt. %) | Brand | (wt. %) | loading (wt. %) |
| Epoxy | G/Flex 650 | 25 | G/Flex 650 | 25 | 50 |
| Polyester | Crystic 2-8500PA | 49.5 | Butanox M50 | 0.5 | 50 |
| Polyester | Crystic 2-446PA | 49 | Butanox M50 | 1 | 50 |
| Polyester | Crystic 397PA | 49 | Butanox M50 | 1 | 50 |
| Polyester | Crystic 397PA | 49 | Interox LA3 | 1 | 50 |
| Vinyl ester | Crystic VE | 49 | Triganox 249 | 1 | 50 |
| | 679-03PA | | | | |
| Polyurethane | EuroCast 1919 | 25 | EuroCast | 25 | 50 |
| | Part A | | 1919 Part B | | |
| Silicone | Silastic 3481 | 45 | Silastic RTC | 5 | 50 |
| | | | 10 | | |
| Epoxy | Sicomin SG 715 | 40 | Sicomin SD | 10 | 50 |
| | | | 802 | | |
| Vinyl ester | Atlac 590 | 49.5 | Butanox M- | 0.5 | 50 |
| | | | 50 | | |
| Polyurethane | Polytek Easyflo | 25 | Polytek | 25 | 50 |
| | 60 PU A | | Easyflo 60 | | |
| | | | PU B | | |
| Polyacrylic | Sika ® Injection- | 35 | Water | 15 | 50 |
| | 310 | | | | |
| Resorcinol- | Aerodux | 42 | Aerodux | 8 | 50 |
| Formaldehyde | 185 Resin | | 185 Hardener | | |
| Resorcinol- | Cascosinol | 44 | Cascosinol | 6 | 50 |
| Formaldehyde | Phenol | | Phenol | | |
| | Rescorcinol | | Rescorcinol | | |
| | Adhesive 1711 | | Hardener | | |
| | | | 2520 | | |
| Urea- | Casco 1205 | 42 | Casco 2581 | 8 | 50 |
| Formaldehyde | | | | | |
| Urea- | Prefere 4152 | 31 | Prefere 5611 | 19 | 50 |
| Formaldehyde | | | | | |

### Example 7 [Prior Art]

A heat battery device was prepared comprising:
a container within which was:
   a heating element located at the bottom of the container;
   a fin-tube heat exchanger located above the heating element;
   a PCM comprising sodium acetate trihydrate which substantially filled the remaining volume of the container; and
   a series of three temperature sensors arranged vertically through the core of the PCM at roughly even spacings.

A loose powder nucleation agent (DSP) was present in the heat battery, located according to its density at the bottom of the heat battery container, in close proximity to the heating element. After charging the heat battery using the resistive electric heating element for 24 hours, the battery was discharged by passing cold mains temperature water through the heat exchanger. As can be seen in FIG. 7, severe subcooling was observed, with the heat battery providing mainly specific heat until the PCM spontaneously nucleated after a prolonged period of subcooling. Thus, it can be demonstrated that:
A PCM without a functioning nucleation agent provides poor performance in a heat battery apparatus
Degradation of the loose nucleation agent material due to its close proximity to the heating element, which produces local temperatures high enough to cause this degradation, may reduce significantly the thermal output of a system comprising such a nucleation agent.
Subcooling causes a significant loss of utilisable thermal energy output from the system

Example 7 therefore shows an example of the state of the art, where nucleation agents are included in the traditional manner, in a loose form and are therefore allowed to move freely through the PCM and collect in locations of the heat battery according to their density.

### Example 8

A heat battery device was prepared comprising:
a container within which was:
   a heating element located at the bottom of the container;
   a fin-tube heat exchanger located above the heating element;
   a PCM comprising sodium acetate trihydrate, and disodium phosphate dihydrate, both of which substantially filled the remaining volume of the container; and
   a series of three temperature sensors arranged vertically through the core of the PCM at roughly even spacings.

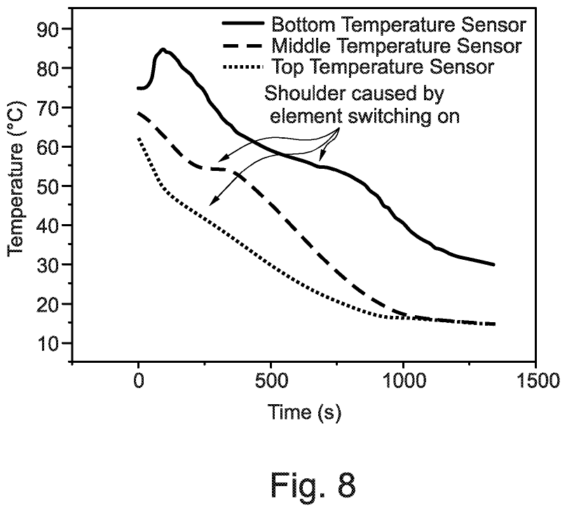

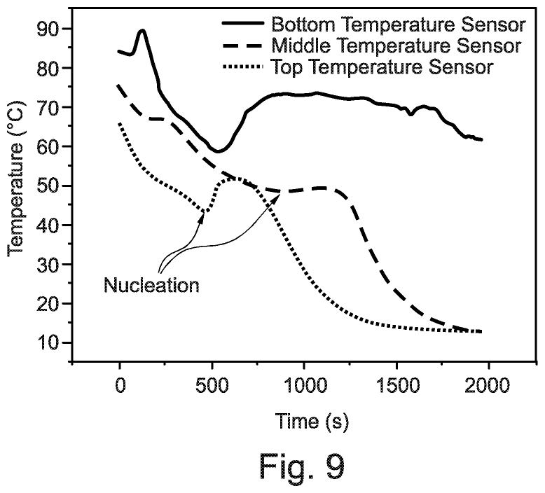

This heat battery device was charged using the electric element and kept above 58° C. for an extended period of time. The battery was then discharged using mains temperature water. Data exemplifying the subcooling of the heat battery apparatus due to deactivation of the nucleator is given in FIG. 8. The internal temperature sensors show a decrease in temperature as the material is cooled, with a slight shoulder caused by the internal element automatically turning on as the material cools below the phase transition temperature (i.e. the temperature the element is set to automatically begin re-charging the PCM). However, no crystallisation of the material is observed. Addition of a nucleation agent piece to the top of the heat battery causes nucleation to occur from the top downwards, as shown in FIG. 9. In this regime, the topmost temperature sensor shows nucleation occurring in its vicinity first, and the crystal growth front proceeding downwards.

Thus means such as a nucleation agent piece, which may be used to reduce subcooling in selectable locations within the heat battery, including avoidance of deleterious degradation processes, is a significant benefit to the thermal performance of a heat battery device comprising a PCM.

### Example 9

A heat battery device was prepared comprising:
a container within which was:
a fin-tube heat exchanger;
a PCM comprising sodium acetate trihydrate which substantially filled the remaining volume of the container;
wherein nucleation agent pieces were located on the uppermost section of:
the heat exchanger heat spreading fins,
the heat exchanger manifolds, and
the inlet pipework which supplies cooling fluid to the heat exchanger
which were still substantially in contact with the PCM.

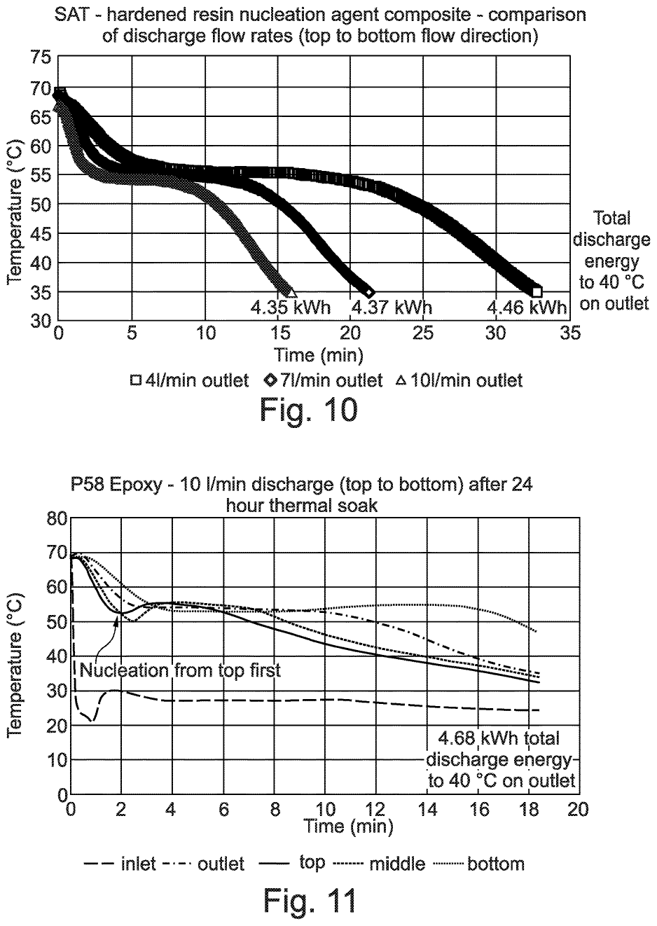

The device was then charged by passing hot water through the heat exchanger pipework until the PCM reached about 70° C. The cell was then discharged by flowing cold water through the heat exchanger, where the cold water flow was directed through the heat exchanger pipework from top of the heat exchanger to the bottom of the heat exchanger and then out of the heat battery device. Thus, the top of the heat battery was cooled before the bottom during discharge. This process was repeated at three different flow rates and the outlet temperatures measured as shown in FIG. 10. Clear discharge plateaus can be seen, indicating the effect of the nucleation agent in the form of a nucleation agent-hardened resin composite. Matching the discharge flow direction (i.e. from the top of the heat exchanger downward) to the location of the nucleation agent pieces (i.e. at the top of the heat exchanger) allows efficient and rapid nucleation at the earliest point in the discharge process.

### Example 10

A heat battery device was prepared comprising:
a container within which was:
a fin-tube heat exchanger;
a PCM comprising sodium acetate trihydrate, and disodium phosphate dihydrate, both of which substantially filled the remaining volume of the container;
a series of three temperature sensors arranged vertically through the core of the PCM at roughly even spacings,
wherein nucleation agent pieces were located on the uppermost section of:
the heat exchanger heat spreading fins,
the heat exchanger manifolds, and
the inlet pipework which supplies cooling fluid to the heat exchanger
which were still substantially in contact with the PCM.

The device was then charged by passing hot water through the heat exchanger pipework until the PCM reached about 70° C. The device was then retained in a charged state for 24 hours to ensure that no seed crystals or other spontaneous nucleation sites were present within the heat battery container.

The cell was then discharged by flowing cold water through the heat exchanger, where the cold water flow was directed through the heat exchanger pipework from top of the heat exchanger to the bottom of the heat exchanger and then out of the heat battery device. Thus, the top of the heat battery was cooled before the bottom during discharge.

The discharge profile of the heat battery, including the temperatures measured by the temperature sensors submerged at various heights within the PCM are shown in FIG. 11. The heat battery was found to nucleate with little to no subcooling, demonstrating the effect of the hardened resin-nucleation agent composite. Furthermore, based on the internal temperature sensors, the crystallisation regime within the heat battery can be ascertained. A rise in temperature was first noted in the uppermost temperature sensor (top in FIG. 11), at the point denoted by the arrow in FIG. 11. Thus, nucleation can be demonstrated to have started at the top of the heat battery, where the hardened resin-nucleation agent pieces were located. Control over the crystal growth regime within the heat battery due to the use of such a piece is thereby demonstrated.

### Example 11

A heat battery device was prepared comprising:
a container within which was:
a resistive heating element located at the bottom of the container;
a fin-tube heat exchanger located above the heating element;
a PCM comprising sodium acetate trihydrate, and disodium phosphate dihydrate, both of which substantially filled the remaining volume of the container;
a series of three temperature sensors arranged vertically through the core of the PCM at roughly even spacings,
wherein nucleation agent pieces were located on the uppermost section of:
the heat exchanger heat spreading fins,
the heat exchanger manifolds, and
the inlet pipework which supplies cooling fluid to the heat exchanger
which were still substantially in contact with the PCM.

The device was then charged via the resistive heating element until each the internal temperature sensors read about 70-77° C.

The cell was then discharged by flowing cold water through the heat exchanger, where the cold-water flow was directed through the heat exchanger pipework from top of the heat exchanger to the bottom of the heat exchanger and then out of the heat battery device. Thus, the top of the heat battery was cooled before the bottom during discharge.

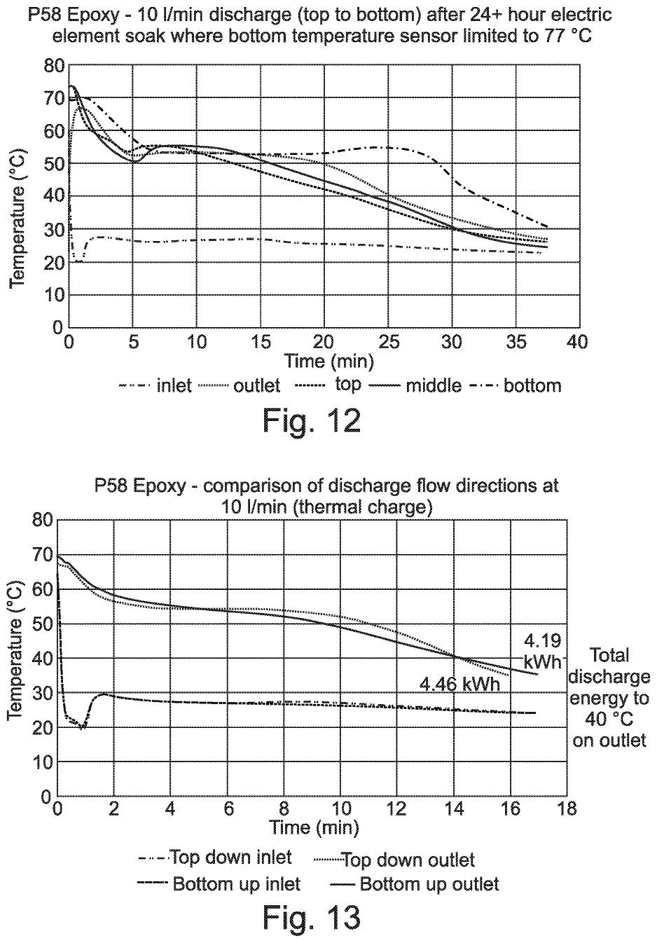

Little to no subcooling could again be noted on discharging the cell (FIG. 12), with nucleation being observed firstly at the top of heat battery device and then trending downwards (i.e. the top sensor shows the inflection upwards associated with crystallisation first).

Thus it is demonstrated that separation of the nucleation agent from a resistive heating element which may inadvertently cause deactivation of the nucleation agent is a means by which the activity of the nucleation agent may be preserved. Compared to Example 7, where the nucleation agent is located in the vicinity of the heating element, far superior performance is achieved in this example, due to the retention of the nucleation agent in its active state. The location of the nucleation agent in a select location where such deactivation processes are not in effect is therefore shown to be of significant advantage in providing a heat battery with improved, reliable, a robust performance.

### Example 12

A heat battery device was prepared comprising:
a container within which was:
a resistive heating element located at the bottom of the container;
a fin-tube heat exchanger located above the heating element;
a PCM comprising sodium acetate trihydrate, and disodium phosphate dihydrate, both of which substantially filled the remaining volume of the container; and
a series of three temperature sensors arranged vertically through the core of the PCM at roughly even spacings,
wherein nucleation agent pieces were located on the uppermost section of:
the heat exchanger heat spreading fins;
the heat exchanger manifolds; and
the inlet pipework which supplies cooling fluid to the heat exchanger which were still substantially in contact with the PCM.

The device was then charged by passing hot water through the heat exchanger pipework until the PCM reached about 70° C.

The cell was then discharged by flowing cold water through the heat exchanger. The cold water used to discharge the heat battery device was either directed through the heat exchanger in a top down manner (i.e. entering the heat exchanger at the top and leaving at the bottom) or a bottom up manner (i.e. entering the heat exchanger at the bottom and leaving at the top). A comparison of these two discharge regimes are shown in FIG. 13. It can be observed that where the flow is matched to the location of the hardened resin-nucleation agent pieces (i.e. top-down discharge), an improved crystallisation plateau is achieved, with higher energy output at a higher temperature than when the discharge flow runs counter to the location of the immobilised nucleator (i.e. bottom up). An improvement of around 5% energy released above 40° C. was achieved by the matching of the flow to the location of the nucleation agent pieces.

### Example 13

A mixture of 50 wt. % of a nucleation agent (in this example disodium phosphate, DSP) and epoxy resin and hardening agent in the mass ratio of 2:1 were prepared, such that the final mass ratio of components was about 50 wt. % DSP, 33 wt. % resin and 17 wt. % hardener.

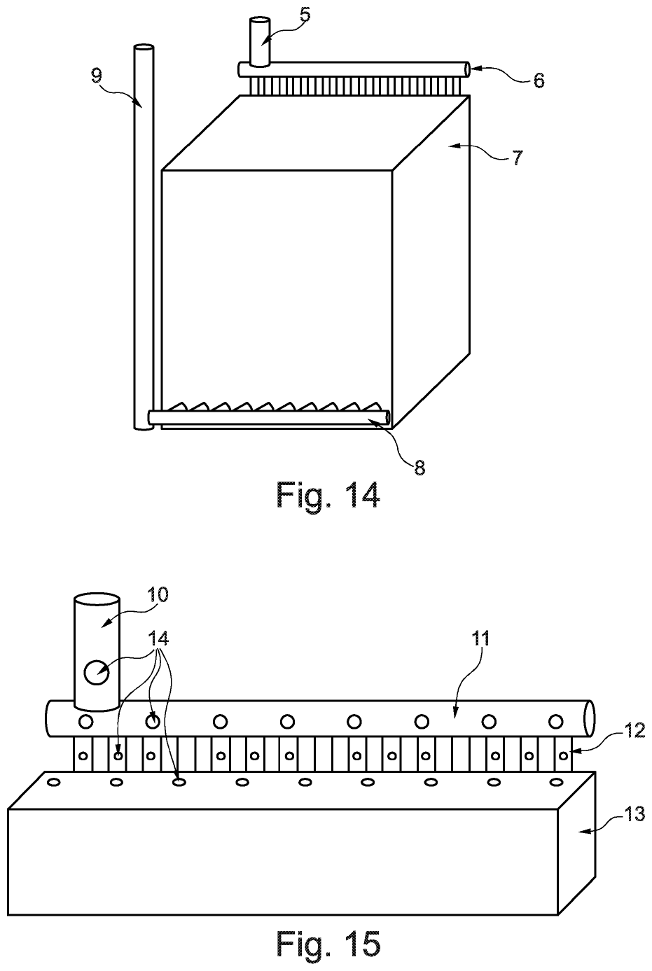

Before hardening took place, the mixture was applied to a various surfaces of a heat exchanger apparatus as described in FIG. 14. The heat exchanger comprised:
an inlet/outlet pipe (5)
an upper manifold (6)
a fin-tube section (7)
a lower manifold (8), and
an inlet/outlet pipe (9).
wherein the fin-tube section comprises a series of tubes connecting manifold (6) and manifold (8) in a serpentine fashion, with intersecting fins arranged vertically.

The resin-hardener-nucleation agent mixture was applied to the inlet/outlet pipe (5), the manifold (6) and the upper surface of the fin-tube section (7). Application of the mixture was achieved by dropping small spots of <0.5 cm³ onto the chosen surfaces, and in some cases spreading the material over the surface with a silicone brush. A series of droplets of the mixture were applied at regular intervals onto the inlet/outlet pipe (5) and upper manifold sections (6). An array of droplets were applied to the upper surface of the fin-tube section (7), where each droplet was arranged at the intersection points of a grid pattern covering the upper surface of the fin-tube section (7).

The heat exchanger was then placed in a container, and PCM (in this example, sodium acetate trihydrate, SAT) was then added such that the areas to which the resin-hardener-nucleation agent was applied were in contact with the PCM when the container was full. The assembled and filled heat battery device could then be charged and discharged via the heat exchanger, with a preferred flow direction of discharge being via inlet/outlet pipe(5), through the manifold (6), fin-tube section (7), lower manifold (8) and then leaving the heat battery via inlet/outlet pipe (9).

It is of note that the exact size, number and location of each of the components described in FIG. 14 is merely exemplary, and any geometry of heat exchanger with differing connectivity relative to FIG. 14 may be used in the disclosed invention. A key aspect of the use of such a heat exchanger is the matching of the location of the hardened resin-nucleation agent to the coolant flow through the heat exchanger.

### Example 14

A mixture of 50 wt. % of a nucleation agent (in this example disodium phosphate, DSP) and epoxy resin and hardening agent in the mass ratio of 2:1 were prepared, such that the final mass ratio of components was about 50 wt. % DSP, 33 wt. % resin and 17 wt. % hardener. Before hardening took place, the mixture was applied to a various surfaces of a heat exchanger apparatus as described in FIG. 14. The nucleation agent, resin and hardener mixture was applied to the heat exchanger using a dropper and silicone brush, wherein the brush was used to spread the mixture over the heat exchanger surfaces.

The heat exchanger comprised:
an inlet/outlet pipe (5)
an upper manifold (6)
a fin-tube section (7)
a lower manifold (8), and
an inlet/outlet pipe (9)
   wherein the fin-tube section comprises a series of tubes connecting manifold (6) and manifold (8) in a serpentine fashion, with intersecting fins arranged vertically.

The resin-hardener-nucleation agent mixture was applied to the inlet/outlet pipe (5), the manifold (6) and the upper surface of the fin-tube section (7). Application of the mixture was achieved by dropping small spots of <0.5 cm³ onto the chosen surfaces, and in some cases spreading the material over the surface with a silicone brush. A series of droplets of the mixture were applied at regular intervals onto the faces of the fin-tube section (7).

The heat exchanger was then placed in a container, and PCM (in this example, sodium acetate trihydrate, SAT) was then added such that the areas to which the resin-hardener-nucleation agent was applied were in contact with the PCM when the container was full. The assembled and filled heat battery device could then be charged and discharged via the heat exchanger, with a preferred flow direction of discharge being via inlet/outlet pipe(5), through the manifold (6), fin-tube section (7), lower manifold (8) and then leaving the heat battery via inlet/outlet pipe (9).

It is of note that the exact size, number and location of each of the components described in FIG. 13 is merely exemplary, and any geometry of heat exchanger with differing connectivity relative to FIG. 13 may be used in the disclosed invention.

### Example 15

A mixture of 50 wt. % of a nucleation agent (in this example disodium phosphate, DSP) and epoxy resin and hardening agent in the mass ratio of 2:1 were prepared, such that the final mass ratio of components was about 50 wt. % DSP, 33 wt. % resin and 17 wt. % hardener. Before hardening took place, the mixture was applied to a various surfaces of a heat exchanger apparatus as described in FIG. 15. The nucleation agent, resin and hardener mixture was applied to the heat exchanger using a dropper and silicone brush, where the brush was used to spread the mixture over the heat exchanger surfaces. The heat exchanger comprised a pipe supplying cooling fluid (10) to a manifold (11) wherein the cooling fluid is split into a series of smaller tubes (12) before passing through a fin-tube section (13) to one or more further manifold(s) and outlet pipe(s). The hardened resin-nucleation agent pieces (in this case an epoxy-DSP composite) were located according to (14) by spreading the mixture onto the pipework and fins. The device was then added into a containment case and molten sodium acetate trihydrate added such that each of the pieces (14) were immersed in the molten PCM. The locations, exact number, shape and size of the hardened resin-nucleation agent pieces shown in FIG. 15 are exemplary only and may be varied. For instance, where a different fill level is used (i.e. less or more molten sodium acetate trihydrate was added), that the hardened resin-nucleation agent pieces may be located at higher or lower levels on the componentry. Furthermore, the use of dramatically fewer hardened resin-nucleation agent pieces may be allowable, with a view to reducing costs and maximising energy storage capacity.

### Example 16

A mixture of a nucleation agent (in this case silicon carbide and titanium dioxide in a 50:50 mass ratio) was added into a mixture of a polyester resin (Crystic 2-446PA) and hardener (Butanox M50) such that the nucleator loading was approximately 50 wt. %, the resin was approximately 49 wt. % and the hardener was approximately 1 wt. %. This material was blended before casting in a rectangular silicone mould to give a nucleator piece of approximately 2 mm×200 mm×400 mm after hardening. Hardening took place in the silicone mould at approximately 25° C. over the course of around 4 hours.

Two holes of approximately 5 mm in diameter were then drilled into the piece, with both holes being approximately 20 mm from one edge of the piece. Using said holes, the piece was located within a heat battery apparatus by hanging from hooks present on a heat exchanger located within the heat battery apparatus the piece by the two holes. The nucleation agent piece was thereby located in close proximity to the heat exchanger, and was therefore in good thermal contact with the heat exchanger.

### Example 17

A mixture of a nucleation agent (in this example silicon dioxide and vermiculite in a 50:50 mass ratio) was added into a polyurethane resin (in this example EuroCast 1919 Part A) and blended with a polyurethane resin hardener (in this example EuroCast 1919 Part B) such that the final blend was about 15 wt. % silicon dioxide, about 15 wt. % vermiculite, about 30 wt. % resin and about 30 wt. % resin hardener. This material was blended before applying to a metal plate (in this example an aluminium plate) in a thin layer. The application was achieved using a roller, leaving a thin coating of the nucleator/resin/resin hardener mixture substantially covering the surface of the metal plate. The mixture was then allowed to cure at ambient conditions over the course of about 6 hours. Thus, a nucleation agent piece in the form of a thin layer adhered to a metal plate was prepared.

The nucleation agent piece modified plate was then used as part of a fin-tube heat exchanger apparatus by drilling a plurality of holes into the plate corresponding to the number and location of holes present in a typical fin forming part of the fin-tube heat exchanger, and arranging the plate in the same manner as the fins forming part of the fin-tube heat exchanger. In other words, the tube(s) which form part of the fin-tube heat exchanger pass through one or more fin(s) and the nucleation agent piece modified plate. A plurality of nucleation agent piece modified plates may be prepared and used in this manner, replacing a plurality of fins which form part of a fin-tube heat exchanger.

Thereby one or more the nucleation agent piece(s) were located forming part of the heat exchanger apparatus.

### Example 18

A mixture of a nucleation agent (in this example zinc oxide) was added into a polyacrylate resin (in this example Sika® Injection-310) and water such that the final mixture was about 10 wt. % nucleation agent, about 63 wt. % resin and about 17 wt. % water. The mixture was then blended until homogeneous and then applied to the walls of a heat battery apparatus containment and a metal (in this example aluminium) plate by doctor blading. Two adhesive plastic strips of approximately 10 micron in thickness were used as spacers and a silicone squeegee was used to spread the mixture between the spacers. Thereby a thin layer of the mixture was applied. The resulting layers were left to harden under ambient conditions over the course of about 3 hours. At this point the spacers were removed, leaving only the hardened nucleation piece as a thin layer applied to the walls of a heat battery containment and the surface of a metal plate.

A heat battery was then assembled using these components as follows. A heat exchanger apparatus was placed within the heat battery containment, with the heat exchanger inlet and outlet pipes arranged substantially vertically out of the heat battery containment. The modified metal plate was arrange with the nucleation agent piece layer facing downward on top of the heat exchanger in the vicinity of the heat exchanger inlet. The PCM (in this example a salt-water eutectic) was then introduced in a liquid state, filling the containment and surrounding the heat exchanger to a level sufficient to come into contact or at least partial contact with the nucleation agent piece located on the heat battery containment walls and/or the nucleation agent piece located on the metal plate. The heat battery containment was then sealed by attaching a lid to the containment and providing seals and gaskets through which the heat exchanger inlet(s) and outlet(s) may pass through the lid.

### Example 19

A mixture of a nucleation agent (in this example zinc oxide nanoparticles) was added into a polyacrylate resin (in this example Sika® Injection-310) and water such that the final mixture was about 10 wt. % nucleation agent, about 63 wt. % resin and about 17 wt. % water. The mixture was then blended until homogeneous and then applied a metal (in this example aluminium) plate by screen-printing. Through the screen-printing window (160 mesh) was applied the nucleation agent/resin/hardener (water) mixture by passing the mixture over the screen-printing window using a silicone squeegee. Thereby a thin layer of the mixture was applied to the metal plate. The resulting layer were left to harden under ambient conditions over the course of about 3 hours. Thereby a nucleation agent piece in the form of a thin layer was prepared on the surface of a metal plate.

### Example 20

A mixture of a nucleation agent (in this example titanium dioxide) was added to an epoxy resin (in this example Sicomin SG 715) and an epoxy resin hardener (in this example Sicomin SD 802) such that the final composition was about 50 wt. % nucleation agent, about 40 wt. % resin and about 10 wt. % hardener. The mixture was blended until homogeneous and then poured into cylindrical silicone moulds with length of approximately 700 mm and diameter of approximately 8 mm to harden. Hardening took placed over the course of about 2 hours under ambient conditions. The hardened nucleation agent pieces were thereby formed in rod-like shapes, and were removed from the mould.

The nucleation agent pieces in the form of rods were then used in a heat battery apparatus as follows. A fin-tube heat exchanger apparatus was provided comprising a plurality of tubes intersecting a plurality of fins, wherein there was a plurality of spaces suitable for a plurality of tubes which were empty and did not comprise a tube, through which the nucleation agent pieces were instead inserted. Thus, a heat exchanger comprising a plurality of nucleation agent pieces in the form of rods was prepared. Said heat exchanger was then inserted into a containment vessel and combined with a PCM (in this example a salt-water eutectic) such that the fill level of the PCM resulted in at least one of the rods being at least in partial contact with the PCM. Thus, a heat battery apparatus comprising a nucleation agent piece in the form of rods inserted into a heat exchanger was prepared.

### Example 21

A mixture of a nucleation agent (in this example titanium dioxide) was added to an epoxy resin (in this example Sicomin SG 715) and an epoxy resin hardener (in this example Sicomin SD 802) such that the final composition was about 10 wt. % nucleation agent, about 70 wt. % resin and about 20 wt. % hardener. The mixture was blended until homogeneous and then sprayed over the surfaces of a fin-tube heat exchanger apparatus by pumping the mixture through a spray bulb arranged between about 50 mm and 300 mm from the heat exchanger apparatus.

After spraying the mixture, it was allowed to harden under ambient conditions over the course of about 5 hours. Thereby a plurality of nucleation agent pieces were applied to the surfaces of a heat exchanger apparatus. The heat exchanger apparatus was then combined within a containment vessel with a PCM (in this example a salt-water eutectic) to provide a complete heat battery apparatus.

### Example 22

A nucleation agent piece was prepared as follows. A nucleation agent (in this example strontium nitrate anhydrous) was combined with a silicone resin (in this example Silastic 3481) and a silicone resin hardener (in this example Silastic RTC 10) such that the composition was about 50 wt. % nucleation agent, about 45 wt. % resin and about 5 wt. % hardener. The mixture was blended until homogeneous and then poured into a square aluminium mould of about 500 mm×500 mm until the mixture filled about the bottom 3 mm of the mould. The mixture was then allowed to harden under ambient conditions for about 16 hours. The hardened nucleation agent piece was found to be flexible and easily removed from the aluminium mould. The nucleation agent piece was then cut into smaller sections of around 31.4 mm×500 mm×3 mm. Said pieces were then used by wrapping the pieces around sections of 10 mm diameter pipework forming part of a heat battery apparatus, using ties to hold the nucleation agent pieces to the pipe surfaces and ensuring that the PCM fill level within the heat battery apparatus was such that at least one part of the nucleation agent pieces were in contact with the PCM.

### Example 23

A mixture of a nucleation agent (in this example disodium phosphate) was added to an epoxy resin (in this example Sicomin SG 715) and an epoxy resin hardener (in this example Sicomin SD 802) such that the final composition was about 50 wt. % nucleation agent, about 25 wt. % resin and about 25 wt. % hardener. The mixture was blended until homogeneous and then poured into cylindrical silicone moulds of approx. 8 mm in diameter and approx. 500 mm in length such that the mould was about ⅓ filled. Aluminium rods of approx. 3 mm in diameter were then also added into the mould such that the rods were in contact with the nucleation agent/resin/hardener mixture. The mixture was then allowed to harden under ambient conditions over the course of about 3 hours. The resulting coating was applied to about one half of the aluminium rod. The partially coated rods were removed from the mould and inserted vertically into a fin-tube heat exchanger with the coated sections arranged towards the top of the fin-tube heat exchanger. Thus, a heat exchanger comprising a nucleation agent piece disposed towards the top of the heat exchanger was prepared. Said heat exchanger was then combined with a heat battery containment vessel and PCM (in this example comprised of sodium acetate trihydrate) such that the coated sections of the aluminium rods were in at least partial contact with the PCM within the heat battery containment.

All ranges described herein are exemplary in nature and include any and all values in between. The terms “approximately” and “about” used herein are interchangeable and refer to a measurement that includes the stated measurement and any measurements reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine. In the event it is determined that individuals having ordinary skill in the relevant arts would not readily ascertain values for such reasonably small differences, the terms “about” and “approximately” can be understood to mean plus or minus 10% of the stated value.

Throughout the description and claims, the terms take the meanings explicitly defined herein, unless the context clearly dictates otherwise.

The phrases “in one embodiment”, “in an embodiment” and “in some embodiments” etc. as used herein do not necessarily refer to the same embodiment(s), though they may.

Furthermore, the phrases “in another embodiment” and “in some other embodiments” as used herein do not necessarily refer to a different embodiment, though they may. All embodiments of the disclosure are intended to be combinable.

The terms “comprises” and “comprising” mean to include but not limited to, such that further features may be present.

1. A nucleation agent piece for nucleating a phase change material (PCM), wherein the nucleation agent piece comprises:
a nucleation agent; and
a hardened resin,
wherein the nucleation agent is dispersed in the hardened resin, and wherein at least a portion of the nucleation agent is present on one or more surface(s) of the hardened resin.

2. A nucleation agent piece according to claim 1, wherein the nucleation agent piece comprises between about 1 and about 90 wt. % of the nucleation agent, and between about 10 and about 99 wt. % of the hardened resin.

3. A nucleation agent piece according to claim 2, wherein the nucleation agent piece comprises between about 10 and about 70 wt. % of the nucleation agent, and between about 30 and about 90 wt. % of the hardened resin.

4. A nucleation agent piece according to any preceding claim, wherein the hardened resin is a polymer selected from any of the following:
epoxy;
polyester;
polyacrylic;
polyvinylester;
polyurethane;
melamine;
resorcinol-formaldehyde;
urea-formaldehyde;
silicone; and
any combination thereof.

5. A nucleation piece according to claim 4, wherein the hardened resin is a hardened epoxy resin.

6. A nucleation agent piece according to any preceding claim, wherein the PCM comprises a salt and water, wherein the salt is any selected from the following:
sodium acetate;
sodium formate;
sodium nitrate;
sodium chloride;
sodium sulfate;
calcium nitrate;
calcium chloride;
calcium bromide;
magnesium nitrate;
magnesium sulfate;
magnesium chloride;
magnesium bromide;
strontium bromide;
strontium chloride;
lithium nitrate;
lithium chloride;
lithium bromide; and
any combination thereof.

7. A nucleation agent piece according to any preceding claim, wherein the nucleation agent comprises a salt, a salt hydrate, an oxide, a carbide, a silicate, or any combination thereof.

8. A nucleation agent piece according to any preceding claim, wherein the nucleation agent comprises a salt which is recrystallised in a hydrated form.

9. A nucleation agent piece according to claim 1, wherein the PCM comprises sodium acetate trihydrate, and the nucleation agent is sodium phosphate, disodium phosphate, trisodium phosphate, tetrasodium pyrophosphate, any hydrates thereof, or any combination thereof.

10. A nucleation agent piece according to claim 1, wherein the PCM comprises calcium nitrate tetrahydrate, and the nucleation agent is magnesium nitrate, strontium nitrate, any hydrates thereof, or any combination thereof.

11. A nucleation agent piece according to claim 1, wherein the PCM comprises calcium nitrate tetrahydrate and the nucleation agent is anhydrous calcium nitrate.

12. A nucleation agent piece according to claim 1, wherein the PCM comprises calcium chloride hexahydrate and/or calcium bromide hexahydrate, and the nucleation agent is strontium chloride, strontium bromide, any hydrates thereof, or any combination thereof.

13. A nucleation agent piece according to claim 1, wherein the PCM comprises a salt-water eutectic selected from any of the following:
Na₂SO₄ (3.5 wt. % in water);
sodium potassium tartrate (5 wt. % in water);
MgSO₄ (19 wt. % in water);
KCl (19.5 wt. % in water);
NH₄Cl (18.6 wt. % in water);
NaOOCH (24.0 wt. % in water);
SrCl₂ (19.5 wt. % in water);
NaNO₃ (35 wt. % in water);
NaOAc (22.7 wt. % in water);
NaOAc (27.0 wt. % in water);
NaCl (22.4 wt. % in water);
LiNO₃ (24.5 wt. % in water);
NaBr (39 wt. % in water);
SrBr₂ (41 wt. % in water); and
Mg(NO₃)₂(29.9 wt. % in water),
and the nucleation agent is any selected from the following:
calcium carbonate;
aluminium oxide;
silicon oxide;
silicon carbide;
silver iodide;
iron oxide;
vermiculite;
titanium dioxide; and
any combination thereof.

14. A nucleation agent piece according to any preceding claim, wherein the nucleation agent piece is macroscopic.

15. A nucleation agent piece according to any preceding claim, wherein the nucleation agent piece has a volume of at least about 0.1 cm³.

16. A nucleation agent piece according to any preceding claim, wherein the nucleating agent piece has a surface area of at least about 0.1 cm².

17. A nucleation agent piece according to claim 1, wherein the hardened resin is a hardened epoxy resin, and the nucleation agent is sodium phosphate, disodium phosphate, trisodium phosphate, tetrasodium pyrophosphate, any hydrates thereof, or any combination thereof.

18. A method of preparing a nucleation agent piece according to any preceding claim, the method comprising:
combining a nucleation agent, a resin, and a resin hardener;
mixing to form a mixture; and
allowing the mixture to harden.

19. A method of preparing a nucleation agent piece according to claim 18, wherein the method comprises combining between about 1 and about 90 wt. % of the nucleation agent, between about 5 and about 75 wt. % of the resin, and between about 2 and about 50 wt. % of the resin hardener.

20. A method according to claim 18 or claim 19, wherein the mixing is performed until the resin and hardener are homogeneously mixed, and optionally until the nucleation agent is wetted or substantially wetted.

21. A method according to any of claims 18-20, wherein the resin is an epoxy resin and the resin hardener is an epoxy resin hardener.

22. A composition comprising a phase change material (PCM) and at least one nucleation agent piece as defined in any of claims 1-17, wherein the at least one nucleation agent piece is in contact with the PCM.

23. A heat battery device comprising:
a container;
a phase change material (PCM) located in the container;
one or a plurality of nucleation agent piece(s) as defined in any of claims 1-17 located in the container; and
one or more means for the addition and removal of heat from the heat battery device.

24. A heat battery device according to claim 23, wherein the nucleation agent piece(s) is/are in direct contact with both the PCM and one or more means for the addition and removal of heat from the heat battery device which.

25. A heat battery device according to claim 23 or claim 24, wherein the nucleation agent piece(s) is/are in direct contact with both the PCM and one or more means for the removal of heat from the heat battery device is/are one or more heat exchanger(s).

26. A heat battery device according to any one of claims 23-25, wherein:
one or more means for the removal of heat from the heat battery device is/are one or more heat exchanger(s), characterised in that the one or more heat exchanger(s) is/are fin-tube heat exchangers with at least one inlet for a heat transfer fluid; and
the nucleation agent piece(s) is/are located in one or more of the locations selected from the following:
on the surface of one or more heat spreading fins of the fin-tube heat exchanger;
on the surface of one or more manifolds of the fin-tube heat exchanger; and
on the surface of one or more heat exchanger cooling inlet pipes of the fin-tube heat exchanger.

27. A heat battery device according to any one of claims 23-26, wherein each nucleation agent piece is less than 50 cm, less than 20 cm, less than 10 cm, less than 5 cm or less than 2 cm apart from another nucleation agent piece.

28. A heat battery device according to claim 23, wherein in addition to the nucleation agent piece(s), the heat battery device further comprises a loose form of the nucleation agent.

29. A method of preparing a heat battery device according to claims 23-28, wherein the heat battery has been in use prior to the addition of the nucleation agent piece(s).

30. A method of preparing a heat battery device according to claims 23-29, comprising: adhering the nucleation agent piece(s) to the one or more means for the removal of heat from the heat battery device by applying a mixture to one or more of the surfaces of the one or more means for the removal of heat from the heat battery device, wherein the mixture comprises a nucleation agent, a resin and a resin hardener; and allowing the mixture to harden.

31. A method of preparing a heat battery device according to claim 29, wherein the means for the removal of heat from the heat battery device is one or more heat exchanger(s), characterised in that the one or more heat exchanger(s) is/are fin-tube heat exchangers, and the method comprises applying the mixture to one or more of the locations selected from:
on the surface of one or more heat spreading fins of the fin-tube heat exchanger;
on the surface of one or more manifolds of the fin-tube heat exchanger; and
on the surface of one or more heat exchanger cooling inlet pipes of the fin-tube heat exchanger.

32. A method of preparing a heat battery device according to claim 30 or claim 31, wherein the resin is an epoxy resin and the resin hardener is an epoxy resin hardener.

33. Use of the nucleation agent piece as defined in claims 1-17 in nucleating a PCM.
